(19) United States
(12) Patent Application Publication
(10) Pub. No.: US 2009/0290473 A1
(43) Pub. Date: Nov. 26, 2009

(54) OPTICAL HEAD DEVICE AND OPTICAL INFORMATION RECORDING OR REPRODUCING APPARATUS WITH THE SAME

(75) Inventor: Ryuichi Katayama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 12/096,467

(22) PCT Filed: Nov. 17, 2006
(86) PCT No.: PCT/JP2006/322928

§ 371 Date: Jun. 6, 2008

(30) Foreign Application Priority Data
Dec. 9, 2005 (JP) 2005-357022

(51) Int. Cl. G11B 7/00

(52) U.S. Cl. 369/109.01; 369/112.23; G9B/7

(57) ABSTRACT

[Problems] An optical head device and an optical information recording or reproducing apparatus are provided to detect an excellent track error signal for two-layer optical recording medium.

[Means for Solving Problems] Reflecting light of a main beam and sub-beams reflected from a disc is diffracted by a diffractive optical element (9a) and then received by a photodetector. The diffractive optical element (9a) is divided into regions (13a) to (13d) by two lines in parallel with radial and tangential directions passing through an optical axis of incident light. Diffracting gratings pitches at the regions (13a) to (13d) become wider in order. A focus error signal is detected by a Foucault's method using a negative first order diffracted light (light deflected to the left side in the drawing) generated from the reflecting light of the main beam while a track error signal is detected by a differential push-pull method using a positive first order diffracted light (light deflected to the right side in the drawing) generated from the reflecting light of the sub-beams.

### TECHNICAL FIELD

The present invention relates to an optical head device and an optical information recording or reproducing apparatus to record and reproduce for an optical recording medium. More particularly, the present invention relates to an optical head device and an optical information recording or reproducing apparatus which can detect an excellent track error signal for a two-layer optical recording medium. The term “recording or reproducing” means at least one of recording and reproducing, that is, means both of recording and reproducing, recording only, or reproducing only.

### BACKGROUND ART

An optical head device to record/reproduce on an optical recording medium has a function of detecting a focus error signal and a track error signal. As a method for detecting the focus error signal, a Foucault's method (or a double knife-edge method), an astigmatism method, a spot-size method and the like are known. A write-once type optical recording medium and a rewritable type optical recording medium include a groove used thereon for tracking. When a light focusing spot formed on the optical recording medium by the optical head device crosses the grooves, noise is generated in a focus error signal. The Foucault's method has a feature that the noise above is suppressed to be small as compared with the astigmatism method and the spot-size method. This feature becomes remarkable in the rewritable type optical recording media (DVD-RAM, HD DVD-RW and the like) with a land/groove recording or reproducing system in which recording/reproduction are performed for a LAND of a concave region in the groove and a GROOVE of a convex region in the groove. Therefore, for these optical recording media, the Foucault's method is generally used as a method for detecting the focus error signal. On the other hand, as a method for detecting a track error signal, a push-pull method is generally used for the write-once type optical recording medium (DVD-R, HD DVD-R and the like) and the rewritable type optical recording medium (DVD-RAM, HD DVD-RW and the like). Therefore, in order to be applicable for the write-once type optical recording medium and the rewritable type optical recording medium, the optical head device is required to include a function of detecting the focus error signal by the Foucault's method and detecting the track error signal by the push-pull method.

In order to miniaturize the optical head device, reflected light from an optical recording medium needs to be received by one same photodetector for detecting these signals. Optical head devices described in Patent Literatures 1 and 2 are known as the optical head device in which the reflected light from the optical recording medium is received by one same photodetector for detecting the focus error signal by the Foucault's method and for detecting the track error signal by the push-pull method.

FIG. 14 shows an optical head device described in Patent Literature 1. Light emitted from a semiconductor laser 1 is collimated by a collimator lens 2, incident as P-polarized light to a polarization beam splitter 4, and almost 100% of which is transmitted through the polarization beam splitter 4, transmitted through a quarter wavelength plate 5 to be converted from linearly polarized light to circularly polarized light, and then focused onto a disc 7 by an objective lens 6. The reflected light from the disc 7 is transmitted through the objective lens 6 in the reverse direction and transmitted through the quarter wavelength plate 5 to be converted from the circularly polarized light to the linearly polarized light whose polarization direction is orthogonal to the light on the incoming way. And then the reflected light from the disc 7 is incident as S-polarized light to the polarization beam splitter 4, and almost 100% of which is reflected, diffracted by a diffractive optical element 9d and transmitted through a convex lens 8 to be received by a photodetector 10c.

FIG. 15 is a plan view of the diffractive optical element 9d. The diffractive optical element 9d is so configured that a diffraction grating, which is divided into four of regions 13i to 13l by a straight line passing through an optical axis of the incident light and being parallel to a radial direction of the disc 7, and a straight line passing through the optical axis of the incident light and being parallel to a tangential direction of the disc 7, is formed. Each direction of diffraction gratings is parallel to the tangential direction of the disc 7, and each pattern of diffraction gratings is formed by straight lines arranged at a regular pitch. The diffraction gratings pitches become wider in order of the regions 13i, 13j, 13k and 13l. Note that a circle shown with a dotted line in the drawing corresponds to an effective diameter 6a of the objective lens 6. About 10% of the light being incident to the regions 13i, 13j, 13k and 13l is diffracted to be negative first order diffracted light, and about 71% thereof is diffracted to be positive first order diffracted light.

FIG. 16 shows a pattern with light receiving sections in the photodetector 10c and arrangement of optical spots on the photodetector 10c. Optical spots 21a and 21b respectively correspond to negative first order diffracted lights from the regions 13i and 13j of the diffractive optical element 9d, and are received by light receiving sections 20a and 20b into which a light receiving section is divided by a dividing line parallel to a radial direction of the disc 7. Optical spots 21c and 21d respectively correspond to negative first order diffracted lights from the regions 13k and 13l of the diffractive optical element 9d, and are received by the light receiving sections 20c and 20d into which a light receiving section is divided by a dividing line parallel to a radial direction of the disc 7. An optical spot 21e corresponds to positive first order diffracted light from the region 13i of the diffractive optical element 9d, and is received by a single light receiving section 20e. An optical spot 21f corresponds to positive first order diffracted light from the region 13j of the diffractive optical element 9d, and is received by a single light receiving section 20f. An optical spot 21g corresponds to positive first order diffracted light from the region 13k of the diffractive optical element 9d, and is received by a single light receiving section 20g. An optical spot 21h corresponds to positive first order diffracted light from the region 13l of the diffractive optical section 9d, and is received by a single light receiving section 20h.

The outputs from the light receiving sections 20a to 20h are represented by V20a to V20h respectively. The focus error signal by the Foucault's method can be obtained from the calculation of (V20a+V20d)−(V20b+V20c). In addition, the track error signal by the push-pull method is obtained from the calculation of (V20e+V20g)−(V20f+V20h). Moreover, an RF signal recorded in the disc 7 can be obtained from the calculation of (V20e+V20f+V20g+V20h).

FIG. 17 shows an optical head device described in Patent Literature 2. Light emitted from the semiconductor laser 1 is collimated by the collimator lens 2, incident to a beam splitter 11, and a part thereof is transmitted through the beam splitter 11 and focused onto the disc 7 by the objective lens 6. A reflected light from the disc 7 is transmitted through the objective lens 6 in the reverse direction, then incident to the beam splitter 11 and a part thereof is reflected. And then the reflected light is transmitted through the convex lens 8 and a beam splitting element 12 and diffracted by a diffractive optical element 9e to be received by a photodetector 10d.

FIG. 18 is a cross sectional view of the beam splitting element 12. The beam splitting element 12 is composed of a prism 31 which is divided into the left side of region and the right side of region by a straight line passing through the optical axis of incident light and being parallel to the tangential direction of the disc 7. Light being incident to the left region of the prism 31 as an incident light 32a is emitted as a refracted light 33a from the prism 31. Light being incident to the right region of the prism 31 as an incident light 32b is emitted as a refracted light 33b from the prism 31.

FIG. 19 is a plan view of the diffractive optical element 9e. The diffractive optical element 9e is so configured that a diffraction grating, which is divided into two of regions 13m and 13n by a straight line passing through the optical axis of the incident light and being parallel to a radial direction of the disc 7, is formed. Each direction of diffraction gratings is parallel to the tangential direction of the disc 7, and each pattern of diffraction gratings is formed by straight lines arranged at a regular pitch. The diffraction gratings pitches become wider in order of the regions 13n to 13m. Note that a circle shown with a dotted line in the drawing corresponds to the effective diameter 6a of the objective lens 6. The diffractive optical element 9e has a polarization-dependency in diffraction efficiency. For the light being incident to the regions 13m and 13n, as to an ordinary light component, about 40.5% thereof is diffracted as negative and positive first order diffracted lights respectively, and as to an extraordinary light component, almost 100% thereof is diffracted as zeroth order light.

FIG. 20 shows a pattern of a light receiving sections of a photodetector 10d and arrangement of optical spots on the photodetector 10d. Optical spots 23a and 23b correspond to zeroth order lights from regions 13m and 13n of a diffractive optical element 9e, of the refracted lights from the left and the right regions of the beam splitting element 12, respectively, and are received by light receiving sections 22a and 22b. Optical spots 23c and 23d correspond to positive first order diffracted lights from the region 13m of the diffractive optical element 9e, of the refracted lights from the left and the right regions of the beam splitting element 12, respectively, and are received by light receiving sections 22c and 22d into which a light receiving section is divided by a dividing line parallel to a radial direction of the disc 7. Optical spots 23e and 23f correspond to positive first order diffracted lights from the region 13n of the diffractive optical element 9e, of the refracted lights from the left and right regions of the beam splitting element 12, respectively, and are received by light receiving sections 22e and 22f into which a light receiving section is divided by a dividing line parallel to a radial direction of the disc 7. Optical spots 23g and 23h correspond to negative first order diffracted lights from the region 13m of the diffractive optical element 9e, of the refracted lights from the left and right regions of the beam splitting element 12, respectively, and are received by a single light receiving section 22g. Optical spots 23i and 23j correspond to negative first order diffracted lights from the region 13n of the diffractive optical element 9e, of the refracted lights from the left and right regions of the beam splitting element 12, respectively, and are received by the single light receiving section 22g.

The outputs from the light receiving sections 22a to 22g are respectively represented by V22a to V22g. The focus error signal by the Foucault's method is obtained from the calculation of (V22c+V22f)−(V22d+V22e). In addition, the track error signal by the push-pull method is obtained from the calculation of (V22a−V22b). Moreover, the RF signal recorded in the disc 7 is obtained from the calculation of (V22a+V22b)−(V22c+V22d+V22e+V22f+V22g).

Patent Literature 1: Japanese Patent Laid-Open Publication No. 2004-139728.

Patent Literature 2: Japanese Patent Laid-Open Publication No. Hei 6-150428.

### DISCLOSURE OF THE INVENTION

### Problems to be Solved by the Invention

A track error signal by a push-pull method in an optical recording medium such as DVD-R, HD DVD-R and the like generates a large offset when an objective lens of an optical head device shifts to a radial direction of the optical recording medium. In order to prevent deterioration of the recording or reproducing characteristics caused by such an offset by the lens shift in the track error signal, a technique in which no offset is generated in the track error signal due to the lens shift is required in the optical head device and the optical information recording or reproducing apparatus.

As a track error signal detection method with which no offset is generated due to the lens shift, a differential push-pull method is generally used. In a case of detecting the track error signal in the optical head device by the differential push-pull method, a diffractive optical element is provided between a light source and an objective lens. By this diffractive optical element, a main beam and a sub-beam are generated as light to be focused onto the optical recording medium by the objective lens, from a light emitted from the light source. And then each reflected light of the main beam and the sub-beam, which is reflected by the optical recording medium, is received individually by a plurality of light receiving sections of a photodetector. The push-pull signals of the main beam and sub-beam are detected from outputs of the light receiving sections, and difference between the push-pull signal of the main beam and the push-pull signal of the sub-beam is defined as the track error signal. Here, a ratio of the amount of light between the main beam and the sub-beam is normally set in 10 to 1 through 20 to 1, in order to prevent data from being erased due to error in the sub-beam upon recording the data in the main beam.

By the way, the optical recording medium such as DVD-R and HD DVD-R has a two-layer standard. In the two-layer optical recording medium, when the main beam is focused onto a layer to which a recording or reproducing is performed, a part of reflected light of the main beam from a layer to which the recording or reproducing is not performed is incident as disturbance light into a light receiving section, which receives the reflected light of the sub-beam from the layer to which the recording or reproducing is performed. The disturbance light causes disturbance of the push-pull signal of the sub-beam and the track error signal by the differential push-pull method. As the reflected light of the main beam from the layer to which the recording or reproducing is not performed expands widely on the photodetector, the incident ratio to the light receiving section which receives the reflected light of the sub-beam from the layer to which the recording or reproducing is performed is small. However, the amount of light of the main beam is larger than that of the sub-beam, therefore the amount of disturbance light cannot be disregarded. In order to prevent deterioration of the recording or reproducing characteristics caused by the disturbance of the track error signal in the two-layer optical recording medium as described above, a technique in which no disturbance is generated in the track error signal in the two-layer optical recording medium is required in the optical head device. However, neither Patent Literatures 1 nor Patent Literature 2 describes the optical head device in which no disturbance is generated in the track error signal in the two-layer optical recording medium.

It is therefore an object of the present invention to solve problems as described above in the optical head device and the optical information recording or reproducing apparatus that receives the reflected light from the optical recording medium by one same photodetector for detecting the focus error signal by the Foucault's method and the track error signal by the push-pull method, and to provide an optical head device and an optical information recoding/reproducing apparatus capable of detecting an excellent track error signal for the two-layer optical recording medium without disturbance in the track error signal in the two-layer optical recording medium.

### Means for Solving the Problems

An optical head device according to the present invention includes: a light source; an objective lens for focusing a light emitted from the light source onto a disk-shaped optical recording medium; a diffractive optical element provided between the light source and the objective lens; a photodetector for receiving a reflected light from the optical recording medium; and a light splitting unit provided between the objective lens and the photodetector. The diffractive optical element has a function of generating a main beam and a sub-beam group to be focused onto the optical recording medium by the objective lens from the light emitted from the light source. The light splitting unit includes a plurality of regions for generating a plurality of main beam split lights and a plurality of sub-beam group split lights respectively from the reflected lights of the main beam and the sub-beam group reflected by the optical recording medium. The photodetector includes: a light receiving section group for the main beam including a plurality of light receiving sections for receiving the plurality of main beam split lights in order to detect a push-pull signal of the main beam; and a light receiving section group for the sub-beam group including a plurality of light receiving sections for receiving the plurality of sub-beam group split lights in order to detect the push-pull signal of the sub-beams. And, one side of the plurality of main beam split lights and one side of the plurality of light receiving sections of the light receiving section group for the main beam are set so as to correspond, the other side of the plurality of main beam split lights and the other side of the plurality of light receiving sections of the light receiving section group for the main beam are set so as to correspond. In other words, each traveling direction of the plurality of main beam split lights and each position of the plurality of light receiving sections of the light receiving section group for the main beam are set so that the plurality of main beam split lights does not cross each other between the light splitting unit and the photodetector.

For example, the main beam split lights generated in the region being located at one side of a straight line passing through the optical axis and being parallel to a direction corresponding to a tangential direction of the optical recording medium, in the light splitting unit, are received by the light receiving sections being located at one side of the straight line passing through the center of the light receiving section group for the main beam and being parallel to a direction corresponding to the tangential direction of the optical recording medium. The main beam split lights generated in the region being located at the other side of a straight line passing through the optical axis and being parallel to a direction corresponding to the tangential direction of the optical recording medium, in the light splitting unit, are received by the light receiving sections being located at the other side of the straight line passing through the center of the light receiving section group for the main beam and being parallel to a direction corresponding to the tangential direction of the optical recording medium. The sub-beams split lights generated in the region being located at one side of a straight line passing through the optical axis and being parallel to a direction corresponding to the tangential direction of the optical recording medium, in the light splitting unit, are received by the light receiving sections being located at one side of the straight line passing through the center of the light receiving section group for the sub-beams and being parallel to a direction corresponding to the tangential direction of the optical recording medium. The sub-beam split lights generated in the region being located at the other side of a straight line passing through the optical axis and being parallel to a direction corresponding to the tangential direction of the optical recording medium, in the light splitting unit, are received by the light receiving sections being located at the other side of the straight line passing through the center of the light receiving section group for the sub-beams and being parallel to a direction corresponding to the tangential direction of the optical recording medium.

To explain in more detail, the optical head device according to the present invention includes: a light source; an objective lens for focusing a light emitted from the light source onto a disk-shaped optical recording medium; a diffractive optical element provided between the light source and the objective lens; a photodetector for receiving a reflected light from the optical recording medium; and a light splitting unit provided between the objective lens and the photodetector. The diffractive optical element generates at least the main beam and the sub-beam group to be focused onto the optical recording medium by the objective lens, from the light emitted from the light source. The light splitting unit is divided at least a first to a fourth regions, in a plane vertical to the optical axis of the reflected light from the optical recording medium, by a straight line passing through the optical axis and being parallel to a direction corresponding to a radial direction of the optical recording medium and a straight line passing through the optical axis and being parallel to a direction corresponding to a tangential direction of the optical recording medium. The light splitting unit generates at least a first to a fourth main beam split lights from the reflected light of the main beam which is reflected by the optical recording medium to be incident to the first to fourth regions respectively, and generates at least a first to a fourth sub-beam group split lights from the reflected lights of the sub-beam group which are reflected by the optical recording medium to be incident to the first to fourth regions. The photodetector includes the light receiving section group for the main beam which receives the first to fourth main beam split lights in order to detect at least the push-pull signal of the main beam, and includes the light receiving section group for the sub-beam group which receives the first to fourth sub-beam group split lights in order to detect at least the push-pull signal of the sub-beams. The first to the fourth main beam split lights do not cross each other between the light splitting unit and the photodetector.

It is preferable that a two-layer optical recording medium is used as the optical recording medium. It is preferable that the photodetector is provided approximately in a position of a focused optical spot of the first to the fourth main beam split lights generated from the reflected light of the main beam being reflected by a layer onto which the main beam focuses in a case where the main beam is focused, by the objective lens, onto a layer being nearer to the objective lens or a layer being farther from the objective lens of the two-layer optical recording medium. It is also preferable that the light splitting unit is provided in a position between the focused optical spot of the reflected light of the main beam being reflected by the layer being farther from the objective lens of the two-layer optical recording medium and the photodetector in a case where the main beam is focused, by the objective lens, onto the layer being nearer to the objective lens of the two-layer optical recording medium. In this case, when the main beam is focused onto the first layer of the two-layer optical recording medium, a part of the reflected light of the main beam being reflected by the second layer is incident as the disturbance light to the light receiving section group for the sub-beam group, but does not cross each other on the light receiving section group for the sub-beam group. Therefore, there is no disturbance in the track error signal.

The light splitting unit may further have a function of generating a fifth to a eighth main beam split lights from the reflected light of the main beam being reflected by the optical recording medium. The photodetector may further include other light receiving section group for the main beam for receiving the fifth to the eighth main beam split lights in order to detect a focus error signal. In this case, as the reflected light from the optical recording medium is received by the one same photodetector in order to detect the focus error signal and the track error signal, the optical head device could be miniaturized.

It is acceptable that the light splitting unit is a diffractive optical element having a single surface on which diffraction gratings are formed. The first to the fourth main beam split lights may be positive first order diffracted lights in the diffraction gratings with respect to the reflected light of the main beam being reflected by the optical recording medium. The first to the fourth sub-beam group split lights may be positive first order diffracted lights in the diffraction gratings with respect to the reflected light of the sub-beam group being reflected by the optical recording medium. The fifth to eighth main beam split lights may be negative first order diffracted lights in the diffraction gratings with respect to the reflected light of the main beam being reflected by the optical recording medium. In this case, as the light splitting unit is a diffractive optical element having a single surface, a configuration of the light splitting unit is simple.

The light splitting unit may be diffractive optical element group having a first surface on which first diffraction gratings are formed and a second surface on which second diffraction gratings are formed. The first to the fourth main beam split lights may be zeroth order lights in the first diffraction gratings and negative or positive first order diffracted light in the second diffraction gratings with respect to the reflected light of the main beam being reflected by the optical recording medium, the first to the fourth sub-beam group split lights may be zeroth order lights in the first diffraction gratings and negative or positive first order diffracted light in the second diffraction gratings with respect to the reflected light of the sub-beam group being reflected by the optical recording medium, and the fifth to the eighth main beam split lights may be negative and positive first order diffracted lights in the first diffraction gratings and the negative or positive first order diffracted light in the second diffraction gratings with respect to the reflected light of the main beam being reflected by the optical recording medium. In this case, it is possible that amount of light used for detecting the focus error signal and amount of light used for detecting the RF signal can be heightened.

The light splitting unit may be diffractive optical element group having a first surface on which first diffraction gratings are formed and a second surface on which second diffraction gratings are formed. The first to the fourth main beam split lights may be zeroth order lights and one of either negative or positive first order diffracted light in the first diffraction gratings, and negative or positive first order diffracted light in the second diffraction gratings with respect to the reflected light of the main beam being reflected by the optical recording medium. The first to the fourth sub-beam group split lights may be zeroth order lights and one of either negative or positive first order diffracted light in the first diffraction gratings, and negative or positive first order diffracted light in the second diffraction gratings with respect to the reflected light of the sub-beam group being reflected by the optical recording medium. The fifth to the eighth main beam split lights may be the other of negative or positive first order diffracted light in the first diffraction gratings, and negative or positive first order diffracted light in the second diffraction gratings with respect to the reflected light of the main beam being reflected by the optical recording medium. In this case, amount of light used for detecting the focus error signal is low compared to the case of configuration as described above, but it is possible that amount of light used for detecting the RF signal can be heightened.

An optical information recording or reproducing apparatus according to the present invention include: an optical head device according to the present invention; a unit for detecting a push-pull signal of the main beam from an output of the light receiving section group for the main beam; a unit for detecting a push-pull signal of the sub-beam group from an output of the light receiving section group for the sub-beam group; and a unit for detecting a track error signal by a differential push-pull method based on a difference between the push-pull signal of the main beam and the push-pull signal of the sub-beam group.

In an optical head device and an optical information recording or reproducing apparatus according to the present invention, when the main beam is focused onto a first layer (a layer being nearer to the objective lens) of the two-layer optical recording medium, the reflected light of the main beam being reflected by a second layer (a layer being farther from the objective lens) is converted to the first to fourth main beam split lights being disturbance lights by the light splitting unit, and a part thereof is incident as disturbance lights to the light receiving section group for the sub-beam group. Further, when the main beam is focused onto a second layer (a layer being farther from the objective lens) of the two-layer optical recording medium, the reflected light of the main beam being reflected by a first layer (a layer being nearer to the objective lens) is converted to the first to fourth main beam split lights being disturbance lights by the light splitting unit, and a part thereof is incident as the disturbance lights to the light receiving section group for the sub-beam group. At this time, the first to fourth main beam split lights as the disturbance light do not cross each other on the light receiving section group for the sub-beam group. Therefore, even if a wavelength of the light source or space between the first layer and the second layer of the optical recording medium is changed, amount of disturbance light being incident to the light receiving section for the sub-beam group does not change. In the result, no disturbance is generated in the push-pull signal of the sub-beam group and the track error signal by the differential push-pull method.

### EFFECTS OF THE INVENTION

As described above, in the optical head device and the optical information recording or reproducing apparatus according to the present invention, it is possible to detect an excellent track error signal for a two-layer optical recording medium without disturbance in the track error signal in the two-layer optical recording medium. The reason is below. When a main beam is focused onto one layer of the two-layer optical recording medium, a reflected light of the main beam being reflected by the other layer is converted into a plurality of main beam split lights being disturbance lights by a light splitting unit, and a part thereof is incident as the disturbance lights to light receiving section group for the sub-beam group. At this time, the plurality of main beam split lights being disturbance lights do not cross each other on the light receiving section group for the sub-beam group.

### BEST MODE FOR CARRYING OUT THE INVENTION

Hereinafter, exemplary embodiments of the invention will be explained with reference to the drawings. FIG. 1 shows a first exemplary embodiment of an optical head device according to the present invention. A light emitted from a semiconductor laser 1 is collimated by a collimator lens 2 and divided into three light beams, that is, zeroth order light as a main beam and negative and positive first order diffracted lights as two sub-beams, by a diffractive optical element 3. These light beams are incident as P-polarized light to a polarization beam splitter 4, and almost 100% of which is transmitted through the polarization beam splitter 4, transmitted through a quarter wavelength plate 5 to be converted from linearly polarized light to circularly polarized light, and then focused onto a disc 7 by an objective lens 6. The three reflected lights from the disc 7 are transmitted through the objective lens 6 in the reverse direction, transmitted the quarter wavelength plate 5 to be converted from the circularly polarized light to the linearly polarized light whose polarization direction is orthogonal to the light on the incoming way. And then the three reflected lights from the disc 7 are incident as S-polarized light to the polarization beam splitter 4, and almost 100% of which are reflected from the polarization beam splitter 4, transmitted through a convex lens 8 and diffracted by a diffractive optical element 9a being a light splitting unit to be received by a photodetector 10a.

FIG. 2 is a plan view of the diffractive optical element 9a. The diffractive optical element 9a is so configured that a diffraction grating, which is divided into four of regions 13a to 13d by a straight line passing through an optical axis of the incident light and being parallel to a radial direction of the disc 7 and a straight line passing through the optical axis of the incident light and being parallel to a tangential direction of the disc 7, is formed. Each direction of the diffraction gratings is parallel to the tangential direction of the disc 7, and each pattern of the diffraction gratings is formed by straight lines arranged at a regular pitch. The diffraction gratings pitches become wider in order of the regions 13a, 13b, 13c and 13d. Note that a circle shown with a dotted line in the drawing corresponds to an effective diameter 6a of the objective lens 6.

FIG. 3 shows a pattern of light receiving sections of the photodetector 10a and arrangement of optical spots on the photodetector 10a. An optical spot 15a corresponds to positive first order diffracted light from the region 13a of the diffractive optical element 9a, out of zeroth order light from the diffractive optical element 3, and is received by a single light receiving section 14a. An optical spot 15b corresponds to positive first order diffracted light from the region 13b of the diffractive optical element 9a, out of zeroth order light from the diffractive optical element 3, and is received by a single light receiving section 14b. An optical spot 15c corresponds to positive first order diffracted light from the region 13c of the diffractive optical element 9a, out of zeroth order light from the diffractive optical element 3, and is received by a single light receiving section 14c. An optical spot 15d corresponds to positive first order diffracted light from the region 13d of the diffractive optical element 9a, out of zeroth order light from the diffractive optical element 3, and is received by a single light receiving section 14d.

Optical spots 15e and 15f respectively correspond to positive first order diffracted light from the regions 13a and 13b of the diffractive optical element 9a, out of positive first order diffracted light from the diffractive optical element 3, and are received by a single light receiving section 14e. Optical spots 15g and 15h are respectively correspond to positive first order diffracted lights from the regions 13c and 13d of the diffractive optical element 9a, out of positive first order diffracted light from the diffractive optical element 3, and are received by a single light receiving section 14f. Optical spots 15i and 15j respectively correspond to positive first order diffracted lights from the regions 13a and 13b of the diffractive optical element 9a, out of negative first order diffracted light from the diffractive optical element 3, and are received by a single light receiving section 14g. Optical spots 15k and 15l respectively correspond to positive first order diffracted lights from the regions 13c and 13d of the diffractive optical element 9a, out of negative first order diffracted light from the diffractive optical element 3, and are received by a single light receiving section 14h.

An optical spot 15m corresponds to negative first order diffracted light from the region 13a of the diffractive optical element 9a, out of zeroth order light from the diffractive optical element 3, and is received by light receiving sections 14i and 14j into which a light receiving section is divided by a dividing line parallel to a radial direction of the disc 7. An optical spot 15n corresponds to negative first order diffracted light from the region 13b of the diffractive optical element 9a, out of zeroth order light from the diffractive optical element 3, and is received by light receiving sections 14k and 14l into which a light receiving section is divided by a dividing line parallel to a radial direction of the disc 7. An optical spot 15o corresponds to negative first order diffracted light from the region 13c of the diffractive optical element 9a, out of zeroth order light from the diffractive optical element 3, and is received by light receiving sections 14m and 14n into which a light receiving section is divided by a dividing line parallel to a radial direction of the disc 7. An optical spot 15p corresponds to negative first order diffracted light from the region 13d of the diffractive optical element 9a, out of zeroth order light from the diffractive optical element 3, and is received by light receiving sections 14o and 14p into which a light receiving section is divided by a dividing line parallel to a radial direction of the disc 7.

Optical spots 15q, 15r, 15s and 15t respectively correspond to negative first order diffracted lights from the regions 13a, 13b, 13c and 13d of the diffractive optical element 9a, out of positive first order diffracted light from the diffractive optical element 3, and are received by a single light receiving section 14q. Optical spots 15u, 15v, 15w and 15x respectively correspond to negative first order diffracted lights from the regions 13a, 13b, 13c and 13d of the diffractive optical element 9a, out of negative first order diffracted light from the diffractive optical element 3, and are received by a single light receiving section 14r. As described above, the light receiving sections 14a to 14d and 14i to 14p correspond to light receiving section group for the main beam. The light receiving sections 14e to 14h, 14q and 14r correspond to light receiving section group for sub-beam group.

Outputs from the light receiving sections 14a to 14r are respectively represented by V14a to V14r. A focus error signal is obtained by the calculation of (V14i+V14l+V14m+V14p)−(V14j+V14k+V14n+V14o) by the Foucault's method. For a play-only type disc, a track error signal is obtained from the phase contrast of (V14a+V14d) and (V14b+V14c) by a phase contrast method. For a write-once type and a rewritable type disc, a push-pull signal of the main beam is given as (V14a+V14b)−(V14c+V14d) and a push-pull signal of the sub-beam is given as (V14e+V14g)−(V14f+V14h). Thus, the track error signal is obtained by the calculation of {(V14a+V14b)−(V14c+V14d)}−K {(V14e+V14g)−(V14f+V14h)} (K represents a constant) by a differential push-pull method. In addition, a RF signal recorded in the disc 7 is obtained by the calculation of (V14a+V14b+V14c+V14d).

FIGS. 4 and 5 show arrangement of optical spots of a reflected light from a non-target layer in a two-layer disc, on the photodetector 10a. These drawings show only the light receiving sections 14a to 14h which receive positive first order diffracted light from the diffractive optical element 9a used for detecting the track error signal. The photodetector 10a is provided in a position of a focused optical spot of positive first order diffracted lights from the regions 13a to 13d of the diffractive optical element 9a, out of zeroth order light from the diffractive optical element 3 as the main beam, in a case where the main beam is focused onto the disc 7.

When the disc 7 is a two-layer disc and the main beam is focused onto a first layer of the disc 7 (a layer being nearer side to the objective lens 6), the focused optical spot of the reflected light of the main beam being reflected by a second layer of the disc 7 (a layer being farther side from the objective lens 6) is located on the nearer side to the objective lens 6 than the photodetector 10a. In this exemplary embodiment, the diffractive optical element 9a is provided between the focused optical spot of the reflected light of the main beam being reflected by the second layer of the disc 7 and the photodetector 10a in a case where the main beam is focused onto the first layer of the disc 7. On the other hand, when the disc 7 is the two-layer disc and the main beam is focused onto the second layer of the disc 7 (a layer being farther side from the objective lens 6), the focused optical spot of the reflected light of the main beam being reflected by the first layer of the disc 7 (a layer being nearer side to the objective lens 6) is located on the farther side from the objective lens 6 than the photodetector 10a.

The diffraction gratings pitches in the diffractive optical element 9a become wider in order of the regions 13a, 13b, 13c and 13d. Therefore, positive first order diffracted lights from the regions 13a to 13d of the diffractive optical element 9a, out of zeroth order light from the diffractive optical element 3 as the main beam does not cross each other between the diffractive optical element 9a and the photodetector 10a. In this case, the reflected light of the main beam being reflected by the second layer of the disc 7 in a case where the main beam is focused onto the first layer of the disc 7, and the reflected light of the main beam being reflected by the first layer of the disc 7 in a case where the main beam is focused onto the second layer of the disc 7 are both diffracted as positive first order diffracted lights in the regions 13a to 13d of the diffractive optical element 9a, and form optical spots 24a to 24d on the light receiving sections as shown in FIG. 4.

The optical spot 24a is positive first order diffracted light from the region 13a of the diffractive optical element 9a. The optical spot 24a spreads in a quarter round shape to an upper right side of the drawing centering on the light receiving section 14a, and a part thereof is incident as disturbance light to the light receiving section 14e. The optical spot 24b is positive first order diffracted light from the region 13b of the diffractive optical element 9a. The optical spot 24b spreads in a quarter round shape to a lower right side of the drawing centering on the light receiving section 14b, and a part thereof is incident as disturbance light to the light receiving section 14g. The optical spot 24c is positive first order diffracted light from the region 13c of the diffractive optical element 9a. The optical spot 24c spreads in a quarter round shape to an upper left side of the drawing centering on the light receiving section 14c, and a part thereof is incident as disturbance light to the light receiving section 14f. The optical spot 24d is positive first order diffracted light from the region 13d of the diffractive optical element 9a. The optical spot 24d spreads in a quarter round shape to a lower left side of the drawing centering on the light receiving section 14d, and a part thereof is incident as disturbance light to the light receiving section 14h.

At this time, the optical spots 24a to 24d being the disturbance light do not overlap each other on the light receiving sections 14e to 14h. Thus, even if a wavelength of the semiconductor laser 1 or a space between the first layer and the second layer of the disc 7 is changed, amount of disturbance light being incident to the light receiving sections 14e to 14h does not change. In the result, no disturbance is generated in the push-pull signal of the sub-beam or the track error signal by the differential push-pull method.

This point will be explained in more detail. The light receiving sections 14a, 14b, 14c and 14d of the photodetector 10a respectively receive positive first order diffracted light, out of the main beam, from the region in which the diffraction gratings pitches is the narrowest, the region in which the diffraction gratings pitches is the second narrowest, the region in which the diffraction grating pitches is the third narrowest, and the region in which the diffraction gratings pitches is the fourth narrowest, in the diffractive optical element 9a. That is, the light receiving sections 14a, 14b, 14c and 14d respectively receive positive first order diffracted lights from the regions 13a, 13b, 13c and 13d. At this time, positive first order diffracted lights from the regions 13a and 13b which are located at the right side of a straight line passing through the optical axis and being parallel to the direction corresponding to a tangential direction of the disc 7, are received by the light receiving sections 14a and 14b, which is located at the right side of a straight line passing through the center of the light receiving sections 14a to 14d and being parallel to the direction corresponding to the tangential direction of the disc 7. The positive first order diffracted lights from the regions 13c and 13d which are located at the left side of a straight line passing through an optical axis and being parallel to the direction corresponding to a tangential direction of the disc 7, are received by the light receiving sections 14c and 14d which are located at the left side of a straight line passing through the center of the light receiving sections 14a to 14d and being parallel to the direction corresponding to the tangential direction of the disc 7. Thus, positive first order diffracted light does not cross between the diffractive optical element 9a and the photodetector 10a each other.

Meanwhile, if the diffraction gratings pitches in the diffractive optical element 9a become narrower in order of the regions 13a, 13b, 13c and 13d, positive first order diffracted lights from the regions 13a to 13d of the diffractive optical element 9a, out of zeroth order light from the diffractive optical element 3 as the main beam cross each other between the diffractive optical element 9a and the photodetector 10a. In this case, the reflected light of the main beam being reflected by the second layer of the disc 7 in a case where the main beam is focused onto the first layer of the disc 7 and the reflected light of the main beam being reflected by the first layer of the disc 7 in a case where the main beam is focused onto the second layer of the disc 7 are both diffracted as the positive first order diffracted light in the regions 13a to 13d of the diffractive optical element 9a, and form the optical spots 24e to 24h on the light receiving sections as shown in FIG. 5.

The optical spot 24e is positive first order diffracted light from the region 13d of the diffractive optical element 9a. The optical spot 24e spreads in a quarter round shape to a lower left side of the drawing centering on the light receiving section 14a, and a part thereof is incident as disturbance light to the light receiving sections 14g and 14h. The optical spot 24f is positive first order diffracted light from the region 13c of the diffractive optical element 9a. The optical spot 24f spreads in a quarter round shape to an upper left side of the drawing centering on the light receiving section 14b, and a part thereof is incident as disturbance light to the light receiving sections 14f and 14e. The optical spot 24g is positive first order diffracted light from the region 13b of the diffractive optical element 9a. The optical spot 24g spreads in a quarter round shape to a lower right side of the drawing centering on the light receiving section 14c, and a part thereof is incident as disturbance light to the light receiving sections 14g and 14h. The optical spot 24h is positive first order diffracted light from the region 13a of the diffractive optical element 9a. The optical spot 24h spreads in a quarter round shape to an upper right side of the drawing centering on the light receiving section 14d, and a part thereof is incident as disturbance light to the light receiving sections 14f and 14e.

At this time, the optical spots 24e and 24g being the disturbance light overlap each other on the light receiving sections 14g and 14h, and the optical spots 24f and 24h being the disturbance lights overlap each other on the light receiving sections 14f and 14e. Thus, when a wavelength of the semiconductor laser 1 or a space between the first layer and the second layer of the disc 7 is changed, amount of disturbance light incident to the light receiving sections 14e to 14h change by the interference. In the result, disturbance is generated in the push-pull signal of the sub-beam and the track error signal by the differential push-pull method.

This point will be explained in more detail. The light receiving sections 14a, 14b, 14c and 14d respectively receive positive first order diffracted lights from the regions 13d, 13c, 13b and 13a. At this time, positive first order diffracted lights from the regions 13d and 13c which are located at the left side of a straight line passing through the optical axis and being parallel to the direction corresponding to a tangential direction of the disc 7, are received by the light receiving sections 14a and 14b which are located at the right side of a straight line passing through the center of the light receiving sections 14a to 14d and being parallel to the direction corresponding to the tangential direction of the disc 7. Positive first order diffracted lights from the regions 13b and 13a which are located at the right side of a straight line passing through the optical axis and being parallel to the direction corresponding to a tangential direction of the disc 7, are received by the light receiving sections 14c and 14d which are located at the left side of a straight line passing through the center of the light receiving sections 14a to 14d and being parallel to the direction corresponding to the tangential direction of the disc 7. Thus, each positive first order diffracted light crosses between the diffractive optical element 9a and the photodetector 10a.

Further, in FIG. 2, when the diffractive optical element 9a in which the diffraction gratings pitches become wider in order of the regions 13a, 13b, 13c and 13d is rotated by 180 degrees (symbols are not changed), the diffraction gratings pitches actually become narrower in order of the regions 13a, 13b, 13c and 13d. When the diffractive optical element 9a is rotated as described above, the corresponding relationship between the regions 13a to 13d of the diffractive optical element 9a and the light receiving sections 14a to 14d of the photodetector 10a is changed. As a result, each positive first order diffracted light is variable in crossing.

FIG. 6 is a sectional view of the diffractive optical element 9a. The diffractive optical element 9a is so configured that a diffraction grating 27a is formed on a substrate 26a. The reflected light from the disc 7 is incident as an incident light 28a to the diffractive optical element 9a, is diffracted as positive first order diffracted light 29a and negative first order diffracted light 30a, and is received by the photodetector 10a. A cross-section of the diffraction grating 27a is in a staircase shape with four levels. The pitch of the diffraction grating 27a is represented by P, and widths of a first to a fourth level are represented by P/2−W, W, P/2−W, and W respectively (In this regard, W/P=0.135). Further, heights of the first to the fourth levels of the diffraction grating 27a are represented by 0, H/4, H/2, and 3H/4, where H=λ(n−1) (In this regard, λ is a wavelength of the incident light 28a and n is a refraction index of the diffraction grating 27a). At this time, the diffraction efficiency of positive first order diffracted light is 71%, and that of negative first order diffracted light is 10%. That is, each light beam injects into the regions 13a to 13d in the diffractive optical element 9a is diffracted to be positive first order diffracted light by 71%, and is diffracted to be negative first order diffracted light by 10%. When a value of W/P is changed, a ratio between the diffraction efficiency of positive first order diffracted light and that of negative first order diffracted light could be changed.

In this exemplary embodiment, the amount of light used for detecting the focus error signal is 10% of the reflected light of the main beam from the disc 7, and the amount of light used for detecting the RF signal is 71% of the reflected light of the main beam from the disc 7. As described above, as the amount of light used for detecting the RF error signal is large compared to the amount of light used for detecting the focus error signal, high ratio of signal to noise with regard to the RF signal can be obtained.

FIG. 7 shows a second exemplary embodiment of the optical head device according to the present invention. Light emitted from the semiconductor laser 1 is collimated by the collimator lens 2 and divided into three light beams, that is, zeroth order light as a main beam and negative and positive first order diffracted lights as two sub-beams, by the diffractive optical element 3. These light beams are incident to the polarization beam splitter 4 as P-polarized light, and almost 100% of which is transmitted through the polarization beam splitter 4, transmitted through a quarter wavelength plate 5 to be converted from linearly polarized light to circularly polarized light, and then focused onto the disc 7 by the objective lens 6. The three reflected lights from the disc 7 are transmitted through the objective lens 6 in the reverse direction, transmitted through the quarter wavelength plate 5 to be converted from the circularly polarized light to the linearly polarized light whose polarization direction is orthogonal to the light on the incoming way. And then the three reflected lights from the disc 7 are incident as S-polarized light to the polarization beam splitter 4, and almost 100% of which are reflected, transmitted through the convex lens 8, divided into a transmitted light and a refracted light by a diffractive optical element 9b, and diffracted by a diffractive optical element 9c being a light splitting unit to be received by a photodetector 10b.

The diffractive optical element 9b includes the diffraction gratings formed on its whole surface. The direction of the diffraction grating is parallel to the tangential direction of the disc 7 and the pattern of the diffraction gratings is linear having regular pitches.

FIG. 8 is a plan view of the diffractive optical element 9c. The diffractive optical element 9c is so configured that a diffraction grating, which is divided into four of regions 13e to 13h by a straight line passing through an optical axis of the incident light and being parallel to a radial direction of the disc 7 and a straight line passing through the optical axis of the incident light and being parallel to a tangential direction of the disc 7, is formed. Each direction of the diffraction gratings is parallel to the tangential direction of the disc 7, and each pattern of the diffraction gratings is formed by straight lines arranged at a regular pitch. The diffraction gratings pitches in the regions 13e and 13h are equal, and the diffraction gratings pitches in the regions 13f and 13g are equal. In addition, the diffraction gratings pitches in the regions 13e and 13h are narrower than the diffraction gratings pitches in the regions 13f and 13g. Please note that a circle shown with a dotted line in the drawing corresponds to the effective diameter 6a of the objective lens 6.

FIG. 9 shows a pattern of light receiving sections of the photodetector 10b and arrangement of optical spots on the photodetector 10b. An optical spot 18a corresponds to the zeroth order light from the diffractive optical element 9b and negative first order diffracted light from the region 13e of the diffractive optical element 9c, out of zeroth order light from the diffractive optical element 3, and is received by a single light receiving section 16a. An optical spot 18b corresponds to zeroth order light from the diffractive optical element 9b and negative first order diffracted light from the region 13f of the diffractive optical element 9c, out of zeroth order light from the diffractive optical element 3, and is received by a single light receiving section 16b. An optical spot 18c corresponds to zeroth order light from the diffractive optical element 9b and positive first order diffracted light from the region 13g of the diffractive optical element 9c, out of zeroth order fight from the diffractive optical element 3, and is received by a single light receiving section 16c. An optical spot 18d corresponds to zeroth order light from the diffractive optical element 9b and positive first order diffracted light from the region 13h of the diffractive optical element 9c, out of zeroth order light from the diffractive optical element 3, and is received by a single light receiving section 16d.

Optical spots 18e and 18f correspond to zeroth order light from the diffractive optical element 9b and negative first order diffracted lights from the regions 13e and 13f of the diffractive optical element 9c respectively, out of positive first order diffracted light from the diffractive optical element 3, and are received by a single light receiving section 16e. Optical spots 18g and 18h correspond to zeroth order light from the diffractive optical element 9b and positive first order diffracted lights from the regions 13g and 13h of the diffractive optical element 9c respectively, out of positive first order diffracted light from the diffractive optical element 3, and are received by a single light receiving section 16f. Optical spots 18i and 18j correspond to zeroth order light from the diffractive optical element 9b and negative first order diffracted lights from the regions 13e and 13f of the diffractive optical element 9c respectively, out of negative first order diffracted light from the diffractive optical element 3, and are received by a single light receiving section 16g. Optical spots 18k and 18l correspond to the zeroth order light from the diffractive optical element 9b and positive first order diffracted lights from the regions 13g and 13h of the diffractive optical element 9c respectively, out of negative first order diffracted light from the diffractive optical element 3, and are received by a single light receiving section 16h.

An optical spot 19a corresponds to negative first order diffracted light from the diffractive optical element 9b and negative first order diffracted light from the region 13e of the diffractive optical element 9c, out of zeroth order light from the diffractive optical element 3, and is received by light receiving sections 17a and 17b into which a light receiving section is divided by a dividing line parallel to a radial direction of the disc 7. An optical spot 19b corresponds to negative first order diffracted light from the diffractive optical element 9b and negative first order diffracted light from the region 13f of the diffractive optical element 9c, out of zeroth order light from the diffractive optical element 3, and is received by light receiving sections 17c and 17d into which a light receiving section is divided by a dividing line parallel to a radial direction of the disc 7. An optical spot 19c corresponds to negative first order diffracted light from the diffractive optical element 9b and positive first order diffracted light from the region 13g of the diffractive optical element 9c, out of zeroth order light from the diffractive optical element 3, and is received by light receiving sections 17e and 17f into which a light receiving section is divided by a dividing line parallel to a radial direction of the disc 7. An optical spot 19d corresponds to negative first order diffracted light from the diffractive optical element 9b and positive first order diffracted light from the region 13h of the diffractive optical element 9c, out zeroth order light from the diffractive optical element 3, and is received by light receiving sections 17g and 17h into which a light receiving section is divided by a dividing line parallel to a radial direction of the disc 7.

An optical spot 19e corresponds to positive first order diffracted light from the diffractive optical element 9b and negative first order diffracted light from the region 13e of the diffractive optical element 9c, out of zeroth order light from the diffractive optical element 3, and is received by light receiving sections 17i and 17j into which a light receiving section is divided by a dividing line parallel to a radial direction of the disc 7. An optical spot 19f corresponds to positive first order diffracted light from the diffractive optical element 9b and negative first order diffracted light from the region 13f of the diffractive optical element 9c, out of zeroth order light from the diffractive optical element 3, and is received by light receiving sections 17k and 17l into which a light receiving section is divided by a dividing line parallel to a radial direction of the disc 7. An optical spot 19g corresponds to positive first order diffracted light from the diffractive optical element 9b and positive first order diffracted light from the region 13g of the diffractive optical element 9c, out of zeroth order light from the diffractive optical element 3, and is received by light receiving sections 17m and 17n into which a light receiving section is divided by a dividing line parallel to a radial direction of the disc 7. An optical spot 19h corresponds to positive first order diffracted light from the diffractive optical element 9b and positive first order diffracted light from the region 13h of the diffractive optical element 9c, out of zeroth order light from the diffractive optical element 3, and is received by light receiving sections 17o and 17p into which a light receiving section is divided by a dividing line parallel to a radial direction of the disc 7.

Optical spots 19i, 19j, 19k and 19l correspond to negative first order diffracted lights from the diffractive optical element 9b and also respectively correspond to negative first order diffracted light from the region 13e, negative first order diffracted light from the region 13f, positive first order diffracted light from the region 13g, and positive first order diffracted light from the region 13h of the diffractive optical element 9c, out of positive first order diffracted light from the diffractive optical element 3, and are received by a single light receiving section 17q. Optical spots 19m, 19n, 19o and 19p correspond to negative first order diffracted lights from the diffractive optical element 9b and also respectively correspond to negative first order diffracted light from the region 13e, negative first order diffracted light from the region 13f, positive first order diffracted light from the region 13g, and positive first order diffracted light from the region 13h of the diffractive optical element 9c, out of negative first order diffracted light from the diffractive optical element 3, and are received by a single light receiving section 17r.

Optical spots 19q, 19r, 19s and 19t correspond to positive first order diffracted lights from the diffractive optical element 9b and also respectively correspond to negative first order diffracted light from the region 13e, negative first order diffracted light from the region 13f, positive first order diffracted light from the region 13g, and positive first order diffracted light from the region 13h of the diffractive optical element 9c, out of positive first order diffracted light from the diffractive optical element 3, and are received by a single light receiving section 17s. Optical spots 19u, 19v, 19w and 19x correspond to positive first order diffracted lights from the diffractive optical element 9b and also respectively correspond to negative first order diffracted light from the region 13e, negative first order diffracted light from the region 13f, positive first order diffracted light from the region 13g, and positive first order diffracted light from the region 13h of the diffractive optical element 9c, out of negative first order diffracted light from the diffractive optical element 3, and are received by a single light receiving section 17t. As described above, the light receiving sections 16a to 16d and 17a to 17p correspond to light receiving section group for the main beam, and the light receiving sections 16e to 16h and 17q to 17t correspond to light receiving section group for the sub-beam group.

The outputs from the light receiving sections 16a to 16h and 17a to 17t are respectively represented by V16a to V16h and V17a to V17t. The focus error signal is obtained by the calculation of (V17a+V17d+V17e+V17h+V17i+V17l+V17m+V17p)−(V17b+V17c+V17f+V17g+V17j+V17k+V17n+V17o) by the Foucault's method. For a play-only type disc, the track error signal is obtained from the phase contrast of (V16a+V16d) and (V16b+V16c) by the phase contrast method. For a write-once type disc and a rewritable type disc, the push-pull signal of the main beam is given as (V16a+V16b)−(V16c+V16d), and the push-pull signal of the sub-beam is given as (V16e+V16g)−(V16f+V16h). Therefore, the track error signal is obtained by the calculation of {(V16a+V16b)−(V16c+V16d)}−K {(V16e+V16g)−(V16f+V16h)} (K represents a constant) by the differential push-pull method. Further, the RF signal recorded on the disc 7 is obtained by the calculation of (V16a+V16b+V16c+V16d).

FIGS. 10 and 11 show arrangement of optical spots of a reflected light from a layer being non-target in a two-layer disc on the photodetector 10b. These drawings show only light receiving sections 16a to 16h which receive zeroth order light from the diffractive optical element 9b and are used for detecting the track error signal. In a case where the main beam is focused onto the disc 7, the photodetector 10b is provided in a position of a focused optical spot of zeroth order light from the diffractive optical element 9b, negative first order diffracted lights from the regions 13e and 13f and positive first order diffracted lights from the regions 13g to 13h of the diffractive optical element 9c, out of zeroth order light from the diffractive optical element 3 as the main beam.

When the disc 7 is the two-layer disc and the main beam is focused onto a first layer (a layer being nearer side to the objective lens 6) of the disc 7, the focused optical spot of the reflected light of the main beam being reflected by a second layer (a layer being farther side from the objective lens 6) of the disc 7 is located on the nearer side to the objective lens 6 than the photodetector lob. In this exemplary embodiment, the diffractive optical element 9c is provided between the focused optical spot of the reflected light of the main beam being reflected by the second layer of the disc 7 and the photodetector 10b in a case where the main beam is focused onto the first layer of the disc 7. On the other hand, when the disc 7 is the two-layer disc and the main beam is focused onto the second layer (a layer being farther side from the objective lens 6) of the disc 7, the focused optical spot of the reflected light of the main beam being reflected by the first layer (a layer being nearer side to the objective lens 6) of the disc 7 is located on the farther side from the objective lens 6 than the photodetector 10b.

Negative first order diffracted lights from the regions 13e and 13f, which are lights being polarized to left side of FIG. 8, and positive first order diffracted lights from the regions 13g and 13h, which are lights being polarized to right side of FIG. 8, are used in the diffractive optical element 9c. Therefore, zeroth order light from the diffractive optical element 9b, which is negative first order diffracted lights from the regions 13e and 13f, and positive first order diffracted lights from the regions 13g and 13h, out of the zeroth order light from the diffractive optical element 3 as the main beam, are do not cross each other between the diffractive optical element 9c and the photodetector 10b. In this case, the reflected light of the main beam being reflected by the second layer of the disc 7 in a case where the main beam is focused onto the first layer of the disc 7, and the reflected light of the main beam being reflected by the first layer of the disc 7 in a case where the main beam is focused onto the second layer of the disc 7 are transmitted through the diffractive optical element 9b as zeroth order light, are diffracted as negative first order diffracted light in the regions 13e and 13f and are diffracted as positive first order diffracted light in the regions 13g and 13h of the diffractive optical element 9c so as to form optical spots 25a to 25d on the light receiving sections as shown in FIG. 10.

The optical spot 25a is zeroth order light from the diffractive optical element 9b and negative first order diffracted light from the region 13e of the diffractive optical element 9c, spreads in a quarter round shape to an upper left side of the drawing centering on the light receiving section 16a, and a part thereof is incident as disturbance light to the light receiving section 16e. The optical spot 25b is zeroth order light from the diffractive optical element 9b and negative first order diffracted light from the region 13f of the diffractive optical element 9c, spreads in a quarter round shape to a lower left side of the drawing centering on the light receiving section 16b, and a part thereof is incident as disturbance light to the light receiving section 16g. The optical spot 25c is zeroth order light from the diffractive optical element 9b and positive first order diffracted light from the region 13g of the diffractive optical element 9c, spreads in a quarter round shape to an upper right side of the drawing centering on the light receiving section 16c, and a part thereof is incident as disturbance light to the light receiving section 16f. The optical spot 25d is zeroth order light from the diffractive optical element 9b and negative first order diffracted light from the region 13h of the diffractive optical element 9c, spreads in a quarter round shape to a lower right side of the drawing centering on the light receiving section 16d, and a part thereof is incident as disturbance light to the light receiving section 16h.

At this time, the optical spots 25a to 25d being the disturbance lights do not overlap each other on the light receiving sections 16e to 16h. Thus, even if a wavelength of the semiconductor laser 1 or a space between the first layer and the second layer of the disc 7 is changed, amount of disturbance lights being incident to the light receiving sections 16e to 16h does not change. As a result, no disturbance is generated in the push-pull signal of the sub-beam and the track error signal by the differential push-pull method.

Meanwhile, if positive first order diffracted lights from the regions 13e and 13f which are to be lights polarized to right side of FIG. 8 and negative first order diffracted lights from the regions 13g and 13h which are to be lights polarized to left side of FIG. 8 are used in the diffractive optical element 9c, zeroth order light from the diffractive optical element 9b, which is positive first order diffracted lights from the regions 13e and 13f, and negative first order diffracted lights from the regions 13g and 13h, out of zeroth order light from the diffractive optical element 3 as a main beam, cross each other between the diffractive optical element 9c and the photodetector 10b. In this case, the reflected light of the main beam being reflected by the second layer of the disc 7 in a case where the main beam is focused onto the first layer of the disc 7, and the reflected light of the main beam being reflected by the first layer of the disc 7 in a case where the main beam is focused onto the second layer of the disc 7 are transmitted through the diffractive optical element 9b as zeroth order light, are diffracted as positive first order diffracted lights in the regions 13e and 13f and are diffracted as negative first order diffracted lights in the regions 13g and 13h of the diffractive optical element 9c so as to form optical spots 25e to 25h on the light receiving sections as shown in FIG. 11.

The optical spot 25e is zeroth order light from the diffractive optical element 9b and negative first order diffracted light from the region 13h of the diffractive optical element 9c, spreads in a quarter round shape to a lower right side of the drawing centering on the light receiving section 16a, and a part thereof is incident as disturbance light to the light receiving sections 16g and 16h. The optical spot 25f is zeroth order light from the diffractive optical element 9b and negative first order diffracted light from the region 13g of the diffractive optical element 9c, spreads in a quarter round shape to an upper right side of the drawing centering on the light receiving section 16b, and a part thereof is incident as disturbance light to the light receiving sections 16f and 16e. The optical spot 25g is zeroth order light from the diffractive optical element 9b and positive first order diffracted light from the region 13f of the diffractive optical element 9c, spreads in a quarter round shape to a lower left side of the drawing centering on the light receiving section 16c, and a part thereof is incident as disturbance light to the light receiving sections 16g and 16h. The optical spot 25h is zeroth order light from the diffractive optical element 9b and positive first order diffracted light from the region 13e of the diffractive optical element 9c, spreads in a quarter round shape to an upper left side of the drawing centering on the light receiving section 16d, and a part thereof is incident as disturbance light to the light receiving sections 16f and 16e.

At this time, the optical spots 25e and 25g being the disturbance lights overlap each other on the light receiving sections 16g and 16h, and the optical spots 25f and 25h being disturbance lights overlap each other on the light receiving sections 16f and 16e. Thus, when a wavelength of the semiconductor laser 1 or a space between the first layer and the second layer of the disc 7 is changed, amount of disturbance light being incident to the light receiving sections 16e to 16h change by the interference. In the result, disturbance is generated in the push-pull signal of the sub-beam and the track error signal by the differential push-pull method.

The diffractive optical element 9b is so configured that diffraction gratings are formed on a substrate. The reflected light from the disc 7 is incident to the diffractive optical element 9b and is divided into three light beams, that is, zeroth order light, negative first order diffracted light, and positive first order diffracted light. A cross-section shape of the diffraction gratings is rectangular. Here, the diffraction gratings pitch is represented by P, and width of a line portion and a space portion are represented by P/2. In addition, height of the diffraction grating is represented by H, where H=0.1143λ(n−1) (In this regard, λ represents a wavelength of the incident light and n represents a refractive index of the diffraction grating). At this time, a transmittance of the zeroth order light becomes 87.6%, a diffraction efficiency of negative first order diffracted light becomes 5.0% and a diffraction efficiency of positive first order diffracted light becomes 5.0%. That is, 87.6% of the light being incident to the diffractive optical element 9b is transmitted through as zeroth order light, 5.0% of which is diffracted as negative first order diffracted light, and 5.0% of which is diffracted as positive first order diffracted light.

FIGS. 12A and 12B are cross-section views of the diffractive optical element 9c. The regions 13e and 13f of the diffractive optical element 9c are so configured that a diffraction grating 27b is formed on a substrate 26b as shown in FIG. 12A. In FIG. 12A, each of zeroth order light and negative and positive first order diffracted lights from the diffractive optical element 9b is incident as an incident light 28b to the diffractive optical element 9c, diffracted as negative first order diffracted light 30b and received by the photodetector 10b. On the other hand, the regions 13g and 13h of the diffractive optical element 9c are so configured that a diffraction grating 27c is formed on the substrate 26b as shown in FIG. 12B. In FIG. 12B, each of the zeroth order light and negative and positive first order diffracted lights from the diffractive optical element 9b is incident as the incident light 28b to the diffractive optical element 9c, diffracted as negative first order diffracted light 29b and received by the photodetector 10b. Cross-section shapes of the diffraction gratings 27b and 27c are saw-tooth shaped.

The pitches of the diffraction gratings 27b and 27c are represented by P. Further, the heights of the diffraction gratings 27b and 27c are represented by H, where H=λ(n−1) (In this regard, λ represents a wavelength of the incident light 28b, n represents a refractive index of the diffraction gratings 27b and 27c). At this time, when a light being polarized to left side of the drawing is represented by a refracted light of a negative order and a light being polarized to right side of the drawing is represented by a refracted light of a positive order, the diffraction efficiency of negative first order diffracted light in the diffraction grating 27b becomes 100%, and the diffraction efficiency of positive first order diffracted light in the diffraction grating 27c becomes 100%. More specifically, the light being incident to the regions 13e and 13f of the diffractive optical element 9c is diffracted as negative first order diffracted light by 100%, and the light being incident to the regions 13g and 13h is diffracted as positive first order diffracted light by 100%.

In this exemplary embodiment, amount of light used for detecting the focus error signal is 10% of the reflected light of the main beam from the disc 7, and amount of light used for detecting the RF signal is 87.6% of the reflected light of the main beam from the disc 7. As described above, the amount of light used for detecting the RF signal is large compared to the amount of light used for detecting the focus error signal. Therefore, high ratio of signal to noise with regard to the RF signal can be obtained.

In this exemplary embodiment, the diffractive optical elements 9b and 9c are provided between the convex lens 8 and the photodetector 10b in this order, but the order of the diffractive optical elements 9b and 9c may be in the reverse order. Further, a single diffractive optical element in which diffraction gratings being the same as the diffraction gratings in the diffractive optical element 9b are formed on one of either an incident surface or an emitting surface, and diffraction gratings being the same as the diffraction gratings in the diffractive optical element 9c are formed on the other of the incident surface or the emitting surface may be used, instead of the diffractive optical elements 9b and 9c.

In this exemplary embodiment, the zeroth order light from the diffractive optical element 9b is used for detecting the track error signal and the RF signal, and negative and positive first order diffracted lights from the diffractive optical element 9b are used for detecting the focus error signal. On the other hand, it is possible that the zeroth order light and one of either negative or positives first order diffracted light from the diffractive optical element 9b are used for detecting the track error signal and the RF signal, and the other of negative and positive first order diffracted light from the diffractive optical element 9b is used for detecting the focus error signal.

FIG. 13 shows a first exemplary embodiment of an optical information recording or reproducing apparatus according to the present invention. This exemplary embodiment is achieved by adding a controller 34, a modulation circuit 35, a recording signal generation circuit 36, a semiconductor laser drive circuit 37, an amplifying circuit 38, a reproducing signal processing circuit 39, a demodulation circuit 40, an error signal generation circuit 41, an objective lens drive circuit 42 and the like to the first exemplary embodiment of the optical head device according to the present invention. The error signal forming circuit 41 corresponds to “calculation unit” in the claims.

The modulation circuit 35 modulates a data, which is to be recorded on the disc 7, in accordance with the modulation rule. The recording signal generation circuit 36 generates the recording signal for driving the semiconductor laser 1 in accordance with a recording strategy based on a signal modulated by the modulation circuit 35. The semiconductor laser drive circuit 37 provides an electric current according to the recording signal to the semiconductor laser 1, based on the recording signal generated in the recording signal generation circuit 36, to drive the semiconductor laser 1. Thereby, the data is written on the disc 7.

The amplifying circuit 38 amplifies outputs from each light receiving section of the photodetector 10a. The reproducing signal processing circuit 39 performs a generation, a waveform equalization and a binarization of the RF signal, based on the signal amplified by the amplifying circuit 38. The demodulation circuit 40 demodulates the signal binarized by the reproducing signal processing circuit 39 in accordance with the demodulation rule. In this manner, the data is reproduced from the disc 7.

The error signal generation circuit 41 generates the focus error signal and the track error signal based on the signal amplified by the amplifying circuit 38. The objective lens drive circuit 42 drives the objective lens 6 by providing an electric current depending on an error signal to an actuator (not shown) for driving the objective lens 6, based on the error signal generated in the error signal generation circuit 41.

Further, optical systems except for the disc 7 are driven to the radical direction of the disc 7 by a positioner (not shown). The disc 7 is rotary-driven by a spindle (not shown). Thereby, a focus servo, a track servo, a positioner servo and a spindle servo are performed.

The circuits being involved in recording of data, from the modulation circuit 35 to the semiconductor laser drive circuit 37, the circuits being involved in reproducing of data, from the amplifying circuit 38 to the demodulation circuit 40, and the circuits being involved in servos, from the amplifying circuit 38 to the objective lens drive circuit 42, are controlled by the controller 34.

In this exemplary embodiment, a recording or reproducing apparatus for recording and reproducing for the disc 7 is described. On the other hand, as another exemplary embodiment of the optical information recording or reproducing apparatus according to the present invention, a reproducing apparatus for performing only a reproduction on the disc 7 could be possible. In this case, the semiconductor laser 1 is not driven based on the recording signal by the semiconductor laser drive circuit 37, but driven so as to keep a certain value for a power of emitted light.

As another exemplary embodiment of the optical information recording or reproducing apparatus according to the present invention, an exemplary embodiment which is achieved by adding a controller, a modulation circuit, a recording signal generation circuit, a semiconductor laser drive circuit, a amplifying circuit, a reproducing signal processing circuit, a demodulation circuit, an error signal generation circuit and an objective lens drive circuit and the like to the second exemplary embodiment of the optical head device according to the present invention could be possible.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This applications is based upon and claims the benefit of priority from Japanese patent applications No. 2005-357022, filed on Dec. 9, 2005, the disclosure of which is incorporated herein in its entirety by reference.

### BRIEF DESCRIPTION OF THE DRAWINGS

FIG. 1 is a block diagram showing a first exemplary embodiment of an optical head device according to the invention;

FIG. 2 is a plan view showing a diffractive optical element in the first exemplary embodiment of the optical head device according to the invention;

FIG. 3 is a plan view showing patterns of light receiving sections of a photodetector and arrangement of optical spots on the photodetector in the first exemplary embodiment of the optical head device according to the invention;

FIG. 4 is a plan view showing arrangement of optical spots on the photodetector of reflected lights from a non-target layer in a two-layer disc in the first exemplary embodiment of the optical head device according to the invention;

FIG. 5 is a plan view showing arrangement of optical spots on the photodetector of reflected lights from a non-target layer in the two-layer disc in the first exemplary embodiment of the optical head device according to the invention;

FIG. 6 is a sectional view showing the diffractive optical element in the first exemplary embodiment of the optical head device according to the invention;

FIG. 7 is a block diagram showing a second exemplary embodiment of the optical head device the according the invention;

FIG. 8 is a plan view showing the diffractive optical element in the second exemplary embodiment of the optical head device according to the invention;

FIG. 9 is a plan view showing patterns of light receiving sections of the photodetector and arrangement of optical spots on the photodetector in the second exemplary embodiment of the optical head device according to the invention;

FIG. 10 is a plan view showing arrangement of optical spots, on the photodetector, of reflected lights from a non-target layer in the two-layer disc in the second exemplary embodiment of the optical head device according to the invention;

FIG. 11 is a plan view showing arrangement of optical spots, on the photodetector, of reflected lights from a non-target layer in the two-layer disc in the second exemplary embodiment of the optical head device according to the invention;

FIG. 12A is a sectional view showing the diffractive optical element in the second exemplary embodiment of the optical head device according to the invention;

FIG. 12B is a sectional view showing the diffractive optical element in the second exemplary embodiment of the optical head device according to the invention;

FIG. 13 is a block diagram showing the first exemplary embodiment of an optical information recording or reproducing apparatus according to the invention;

FIG. 14 is a block diagram showing a conventional optical head device;

FIG. 15 is a plan view showing the diffractive optical element in the conventional optical head device;

FIG. 16 is a plan view showing patterns of light receiving sections of the photodetector and arrangement of optical spots on the photodetector in the conventional optical head device;

FIG. 17 is a block diagram showing a conventional optical head device;

FIG. 18 is a sectional view showing a beam splitting element in the conventional optical head device;

FIG. 19 is the diffractive optical element in the conventional optical head device; and

FIG. 20 is a plan view showing patterns of light receiving sections of the photodetector and arrangement of light spots on the photodetector in the conventional optical head device.

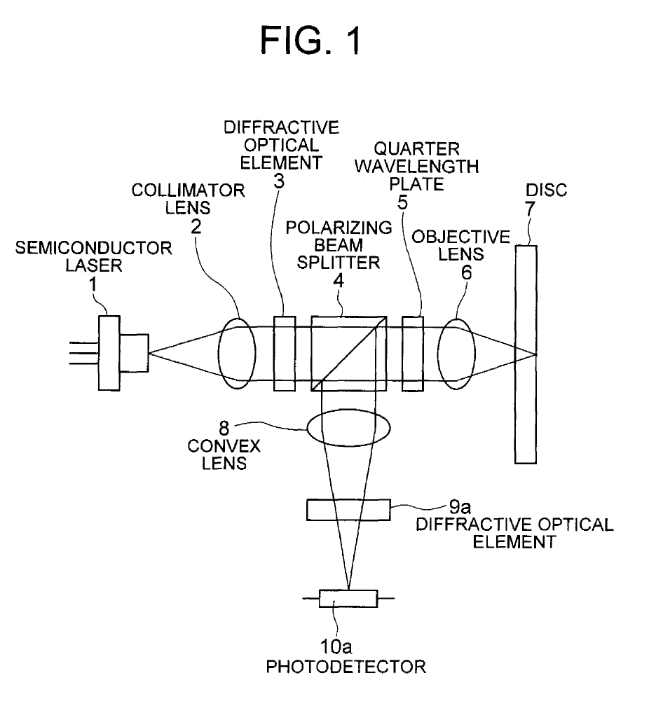

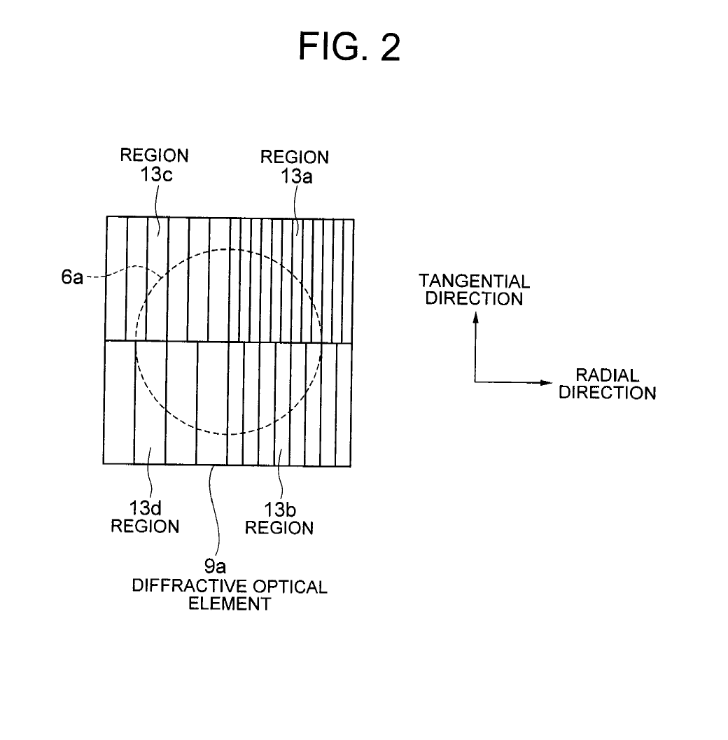

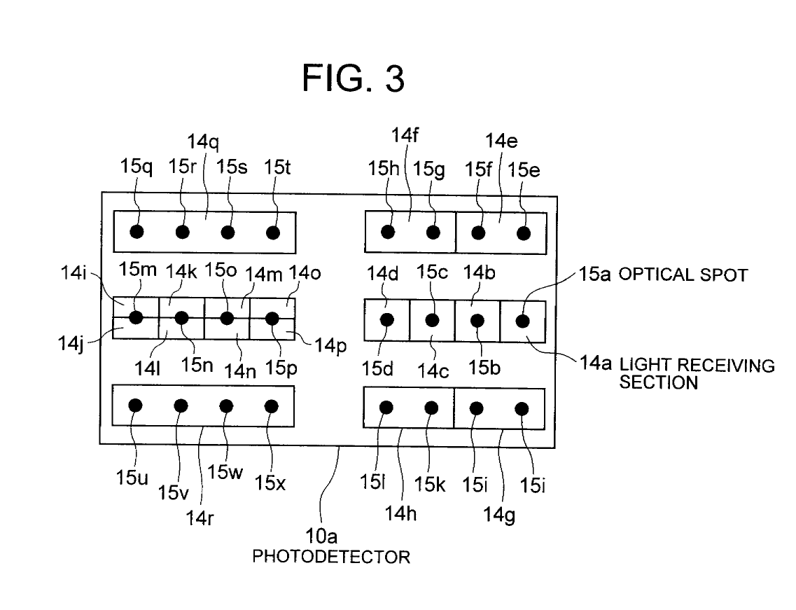

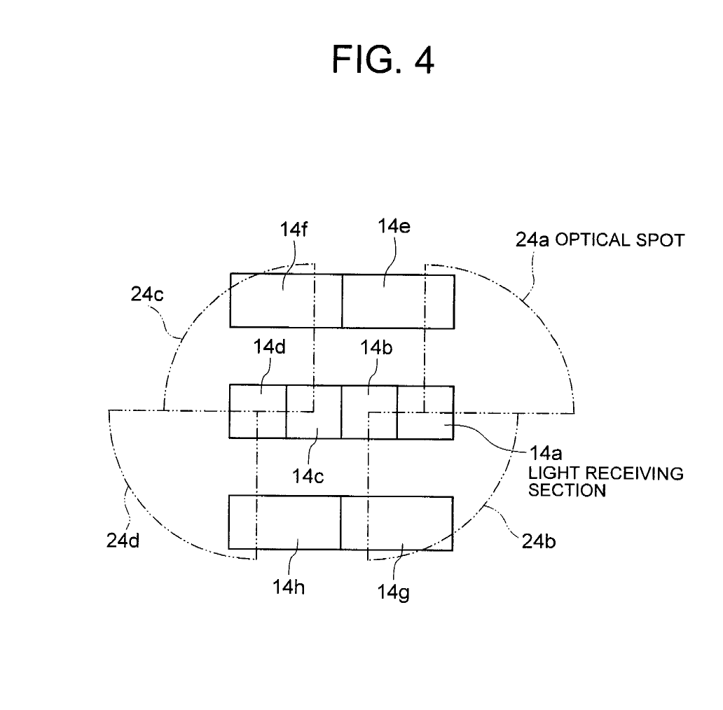

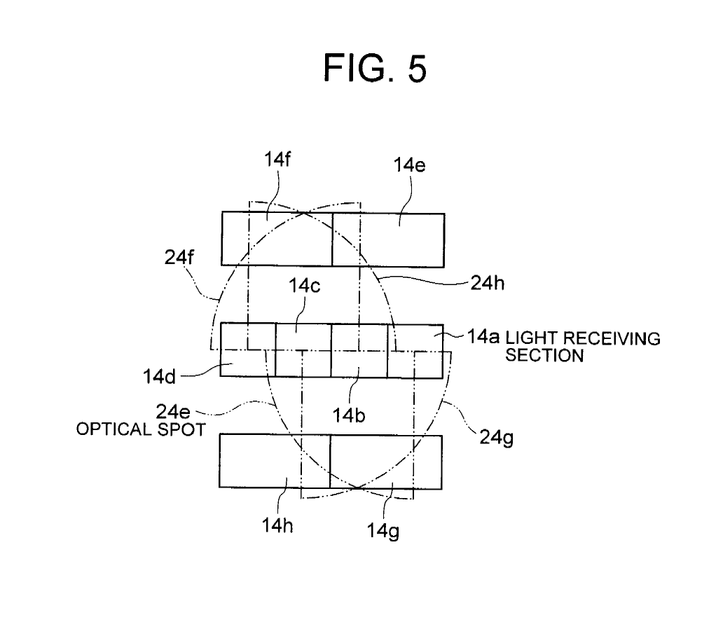

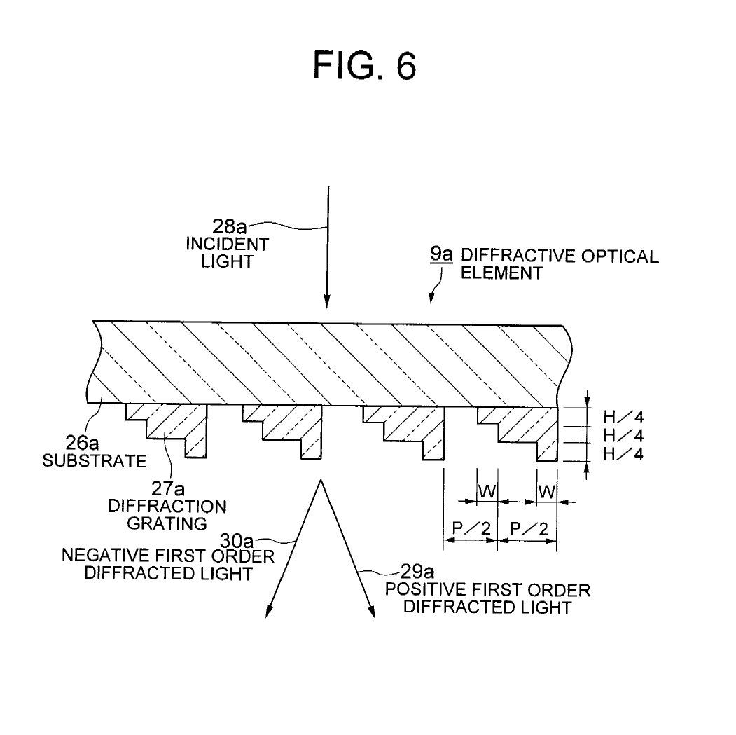

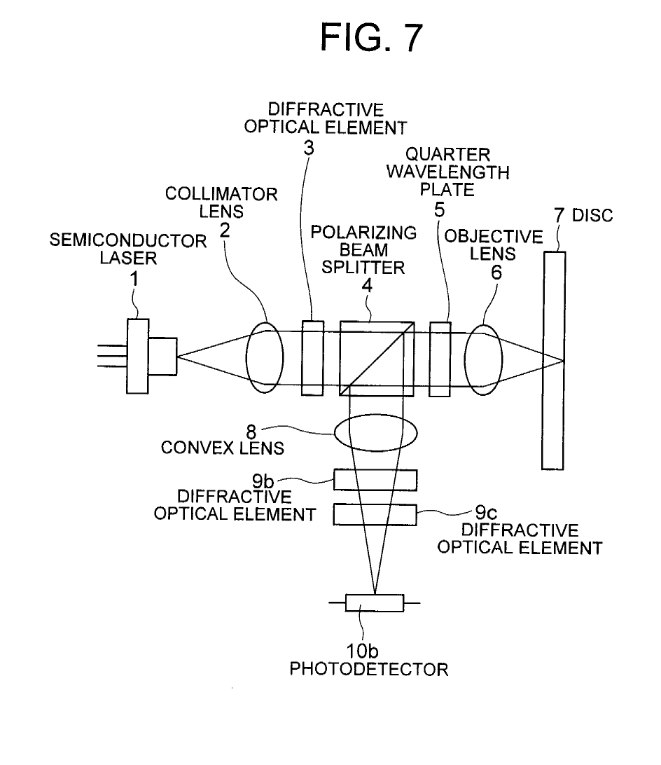

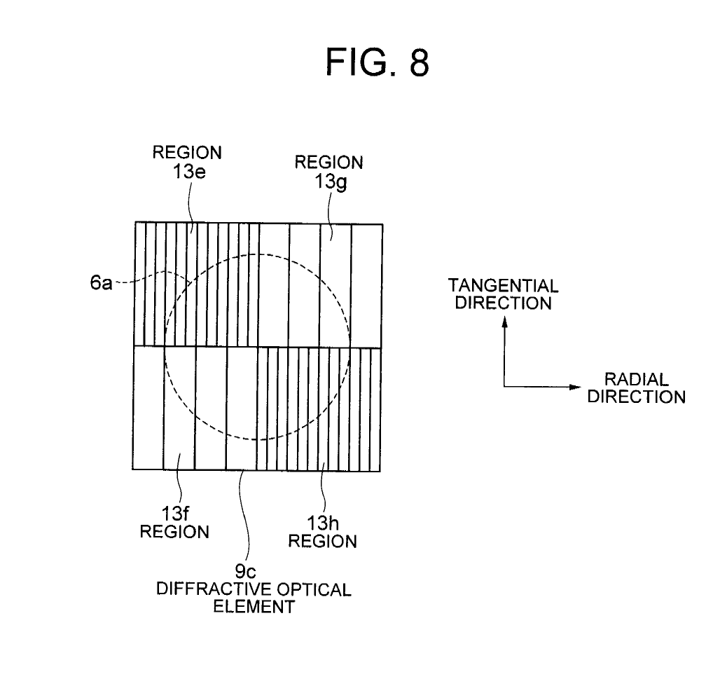

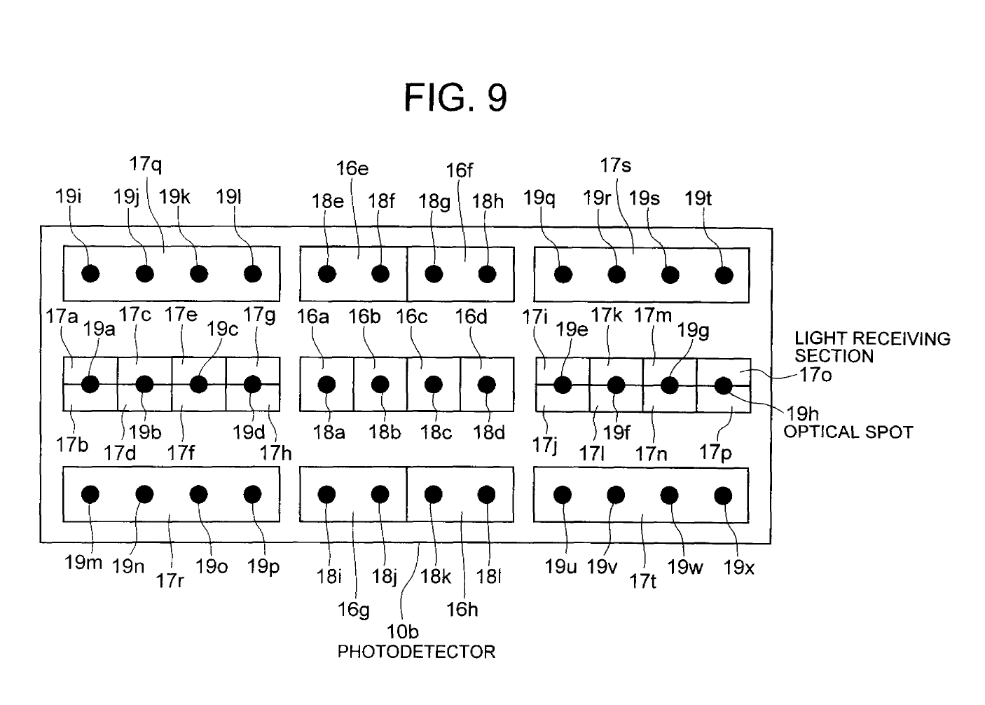

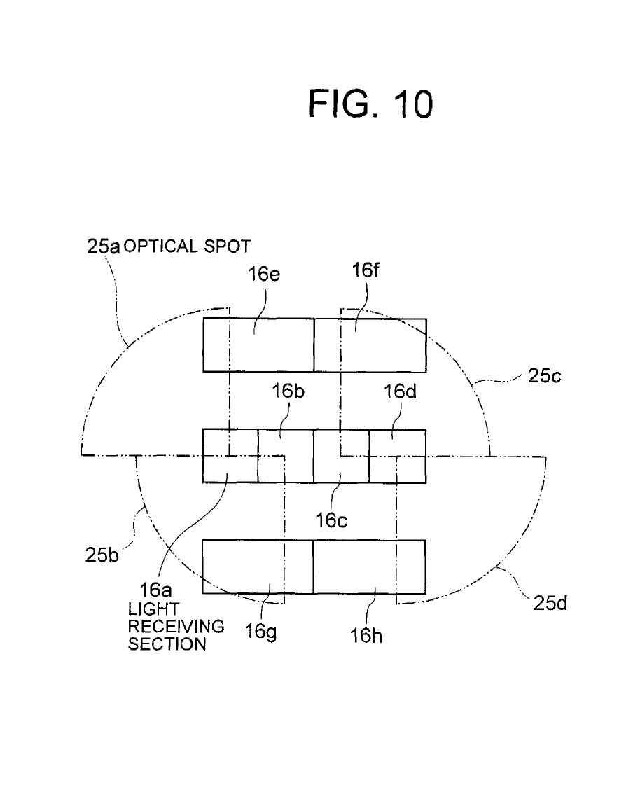

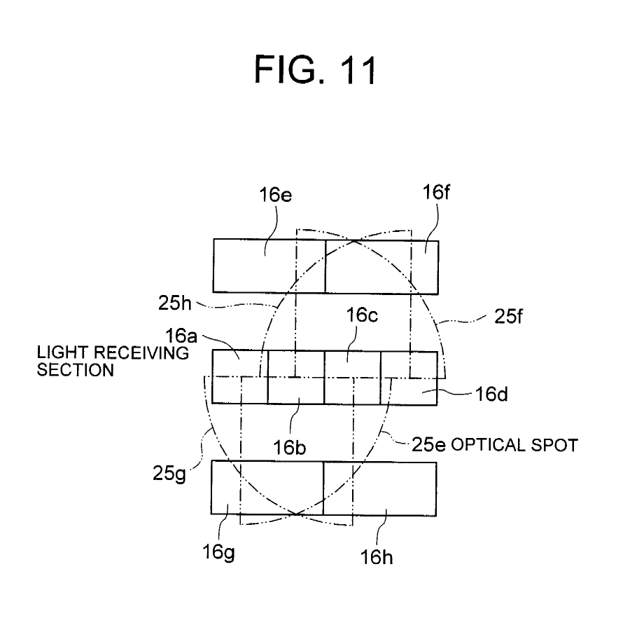

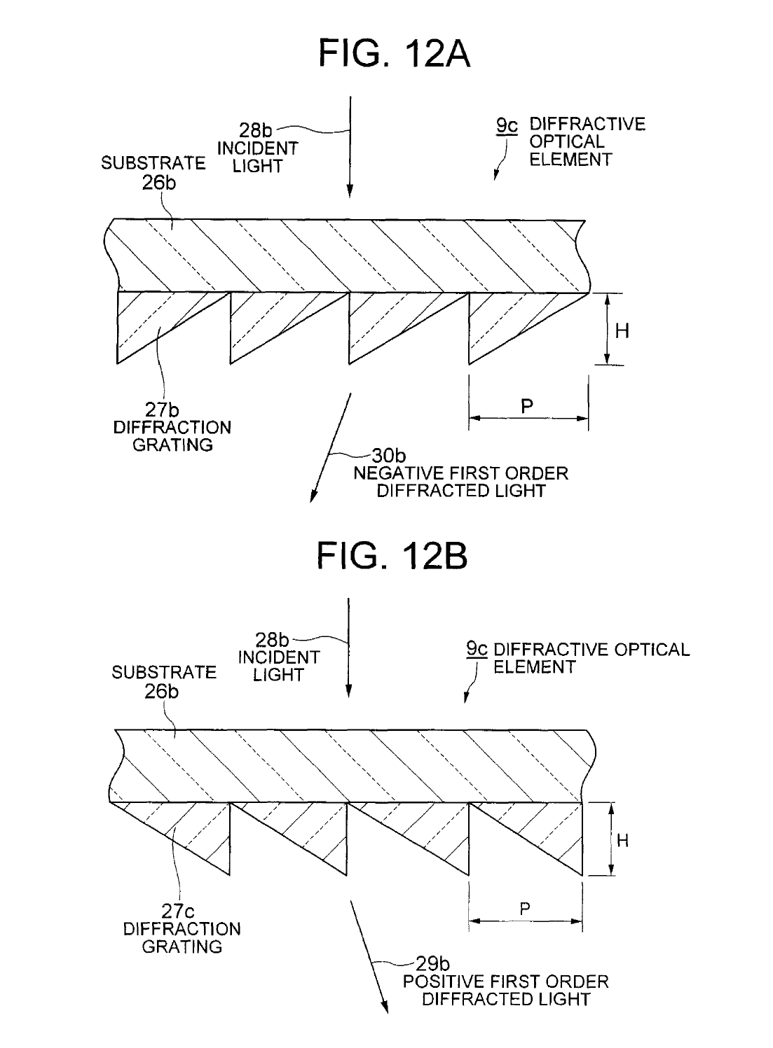

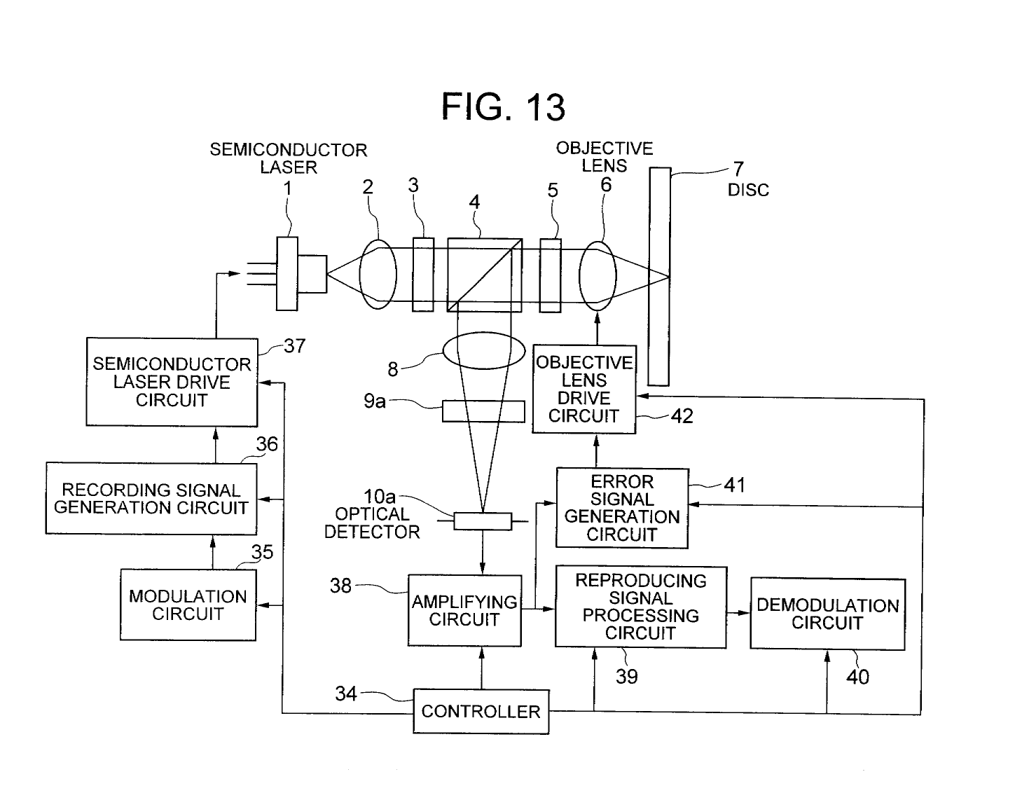

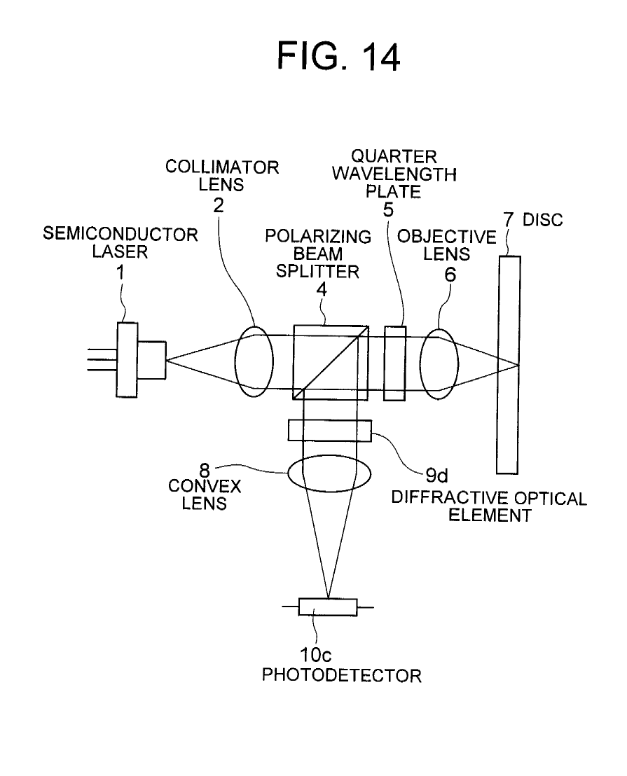

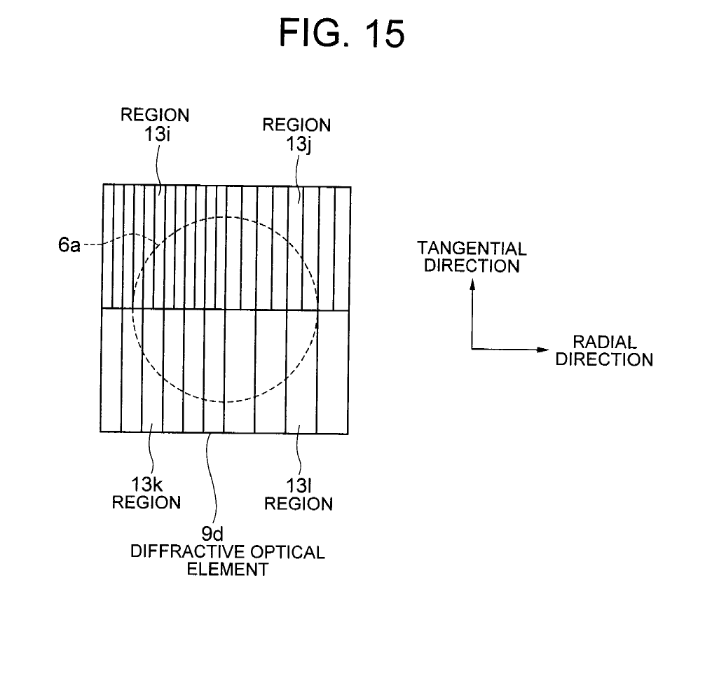

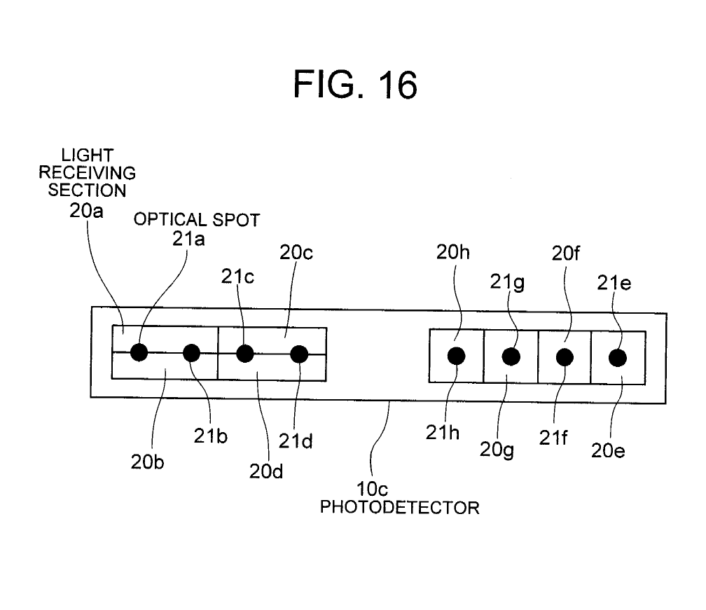

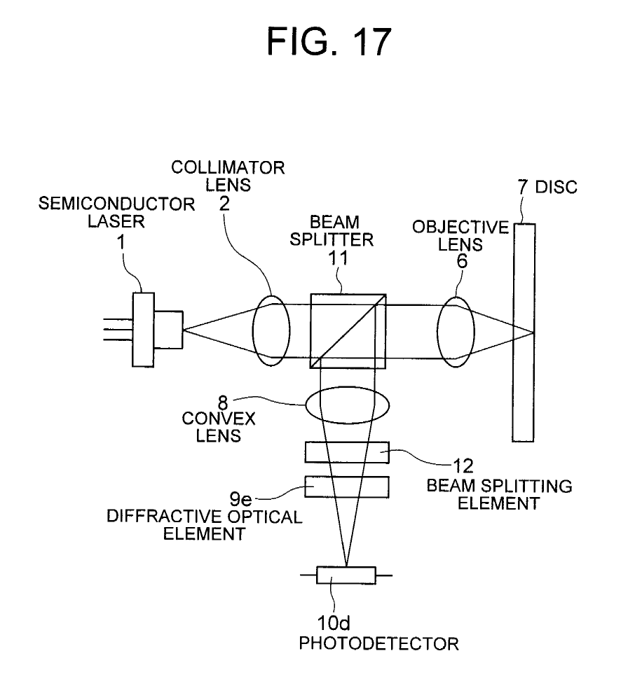

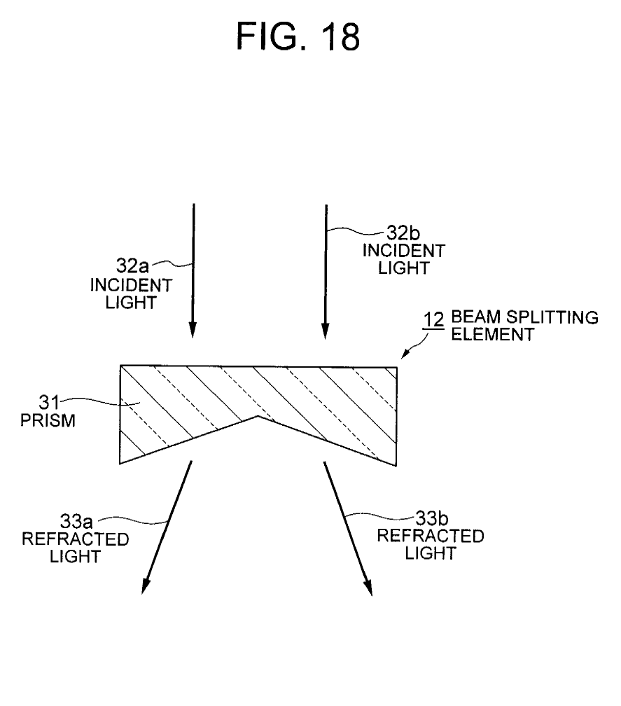

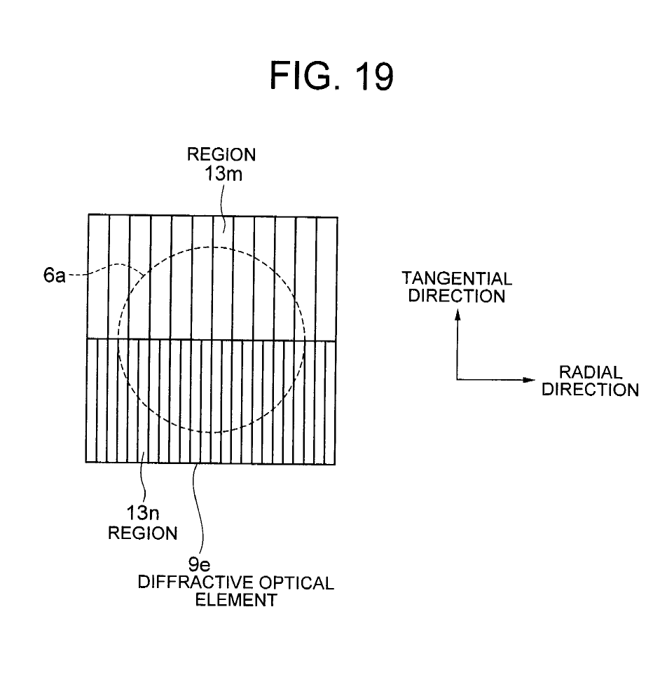

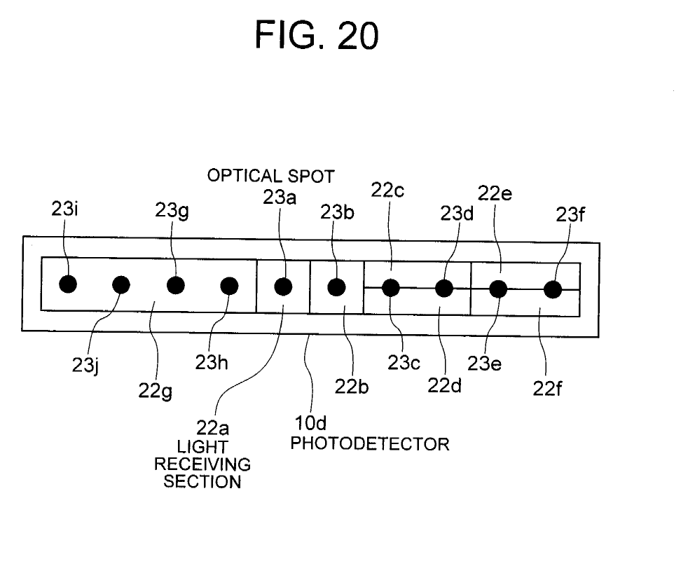

### DESCRIPTION OF REFERENCE NUMERALS

1 semiconductor laser (light source)
2 collimator lens
3 diffractive optical element
4 polarization beam splitter
5 quarter wavelength plate
6 objective lens
36 recording signal generation circuit
37 semiconductor laser drive circuit
38 amplifying circuit
39 reproducing signal processing circuit
40 demodulation circuit
41 error signal generation circuit (calculation unit)
42 objective lens drive circuit.

1. An optical head device comprising:
a light source;
an objective lens for focusing a light emitted from the light source onto a disk-shaped optical recording medium;
a diffractive optical element provided between the light source and the objective lens;
a photodetector for receiving a reflected light from the optical recording medium; and
a light splitting unit provided between the objective lens and the photodetector, wherein
the diffractive optical element has a function of generating a main beam and sub-beam group, which are focused onto the optical recording medium by the objective lens, from the light emitted from the light source,
the light splitting unit comprises a plurality of regions for generating a plurality of main beam split lights and a plurality of sub-beam group split lights respectively from reflected lights of the main beam and the sub-beam group being reflected by the optical recording medium,
the photodetector comprises: light receiving section group for the main beam including a plurality of light receiving sections for receiving the plurality of main beam split lights in order to detect a push-pull signal of the main beam; and light receiving section group for the sub-beam group including a plurality of light receiving sections for receiving the plurality of sub-beam group split lights in order to detect a push-pull signal of the sub-beam group,
one side of the plurality of main beam split lights with respect to an optical axis of the reflected light and one side of the plurality of light receiving sections of the light receiving section group for the main beam with respect to its center are provided so as to correspond, and the other side of the plurality of main beam split lights with respect to the optical axis of the reflected light and the other side of the plurality of light receiving sections of the light receiving section group for the main beam with respect to its center are provided so as to correspond.

2. The optical head device as claimed in claim 1, wherein:
the main beam split lights generated in the region being located at one side of a straight line passing through the optical axis of the reflected light and being parallel to a direction corresponding to a tangential direction of the optical recording medium, in the light splitting unit, are received by the light receiving sections being located at one side of a straight line passing through the center of the light receiving section group for the main beam and being parallel to the direction corresponding to the tangential direction of the optical recording medium;
the main beam split lights generated in the region being located at the other side of the straight line passing through the optical axis of the reflected light and being parallel to the direction corresponding to the tangential direction of the optical recording medium, in the light splitting unit, are received by the light receiving sections being located at the other side of the straight line passing through the center of the light receiving section group for the main beam and being parallel to the direction corresponding to the tangential direction of the optical recording medium;
the sub-beam group split lights generated in the region being located at one side of a straight line passing through the optical axis of the reflected light and being parallel to the direction corresponding to the tangential direction of the optical recording medium, in the light splitting unit, are received by the light receiving sections being located at one side of a straight line passing through the center of the light receiving section group for the sub-beam group and being parallel to the direction corresponding to the tangential direction of the optical recording medium; and
the sub-beam group split lights generated in the region being located at the other side of the straight line passing through the optical axis of the reflected light and being parallel to the direction corresponding to the tangential direction of the optical recording medium, in the light splitting unit, are received by the light receiving sections being located at the other side of the straight line passing through the center of the light receiving section group for the sub-beam group and being parallel to the direction corresponding to the tangential direction of the optical recording medium.

3. The optical head device as claimed in claim 1, wherein the light splitting unit includes, in a plane vertical to the optical axis of the reflected light from the optical recording medium, a first to a fourth regions which are divided by a straight line passing through the optical axis and being parallel to a direction corresponding to a radial direction of the optical recording medium and a straight line passing through the optical axis and being parallel to a direction corresponding to a tangential direction of the optical recording medium, and generates a first to a fourth main beam split lights and a first to a fourth sub-beam group split lights, from the reflected lights of the main beam and the sub-beam group being reflected by the optical recording medium, in the first to the fourth regions.

4. The optical head device as claimed in claim 3, wherein when an optical recording medium including two recording layers is used as the optical recording medium and a layer of the two recording layers being nearer to the objective lens is represented by a first layer and a layer being farther from the objective lens is represented by a second layer,
the photodetector is provided in a position of focused optical spots of the first to the fourth main beam split lights generated from the reflected light of the main beam being reflected by the first layer or the second layer onto which the main beam is focused, in a case where the main beam is focused onto the first layer or the second layer by the objective lens, and
the light splitting unit is provided between the photodetector and a focused light spot of the reflected light of the main beam being reflected by the second layer in a case where the main beam is focused onto the first layer by the objective lens.

5. The optical head device as claimed in claim 3, wherein the light splitting unit further has a function of generating a fifth to an eighth main beam split lights from the reflected light of the main beam being reflected by the optical recording medium, and
the photodetector further comprises another light receiving section group for the main beam for receiving the fifth to the eighth main beam split lights in order to detect a focus error signal.

6. The optical head device as claimed in claim 5, wherein the light splitting unit is a diffractive optical element having a single surface on which diffraction gratings are formed,
the first to the fourth main beam split lights are positive first order diffracted lights in the diffraction gratings with respect to the reflected light of the main beam being reflected by the optical recording medium,
the first to the fourth sub-beam group split lights are positive first order diffracted lights in the diffraction gratings with respect to the reflected lights of the sub-beam group being reflected by the optical recording medium, and
the fifth to the eighth main beam split lights are negative first order diffracted lights in the diffraction gratings with respect to the reflected light of the main beam being reflected by the optical recording medium.

7. The optical head device as claimed in claim 5, wherein the light splitting unit is diffractive optical element group having a first surface on which first diffraction gratings are formed and a second surface on which second diffraction gratings are formed,
the first to the fourth main beam split lights are zeroth order lights in the first diffraction gratings and negative or positive first order diffracted lights in the second diffraction gratings with respect to the reflected light of the main beam being reflected by the optical recording medium,
the first to the fourth sub-beam group split lights are zeroth order lights in the first diffraction gratings and negative or positive first order diffracted lights in the second diffraction gratings with respect to the reflected lights of the sub-beam group being reflected by the optical recording medium, and
the fifth to the eighth main beam split lights are positive and negative first order diffracted lights in the first diffraction gratings and negative or positive first order diffracted lights in the second diffraction gratings with respect to the reflected light of the main beam being reflected by the optical recording medium.

8. The optical head device as claimed in claim 5, wherein the light splitting unit is diffractive optical element group having a first surface on which first diffraction gratings are formed and a second surface on which second diffraction gratings are formed,
the first to the fourth main beam split lights are zeroth order lights and one of negative and positive first order diffracted lights in the first diffraction gratings, and negative or positive first order diffracted lights in the second diffraction gratings with respect to the reflected light of the main beam being reflected by the optical recording medium,
the first to the fourth sub-beam group split lights are zeroth order lights and one of negative and positive first order diffracted light in the first diffraction gratings, and negative or positive first order diffracted lights in the second diffraction gratings with respect to the reflected lights of the sub-beam group being reflected by the optical recording medium, and
the fifth to the eighth main beam split lights are the other of negative and positive first order diffracted lights in the first diffraction gratings, and negative or positive first order diffracted lights in the second diffraction gratings with respect to the reflected light of the main beam being reflected by the optical recording medium.

9. An optical information recording or reproducing apparatus comprising:
the optical head device as claimed in claim 1,
a first calculation unit for detecting the push-pull signal of the main beam based on output signals of the light receiving section group for the main beam,
a second calculation unit for detecting the push-pull signal of the sub-beam group based on output signals of the light receiving section group for the sub-beam group, and
a third calculation unit for detecting a track error signal by a differential push-pull method based on a difference between the push-pull signal of the main beam and the push-pull signal of the sub-beam group.

10. An optical information recording or reproducing apparatus comprising:
the optical head device as claimed in claim 5,
a first calculation unit for detecting the push-pull signal of the main beam based on output signals of the light receiving section group for the main beam,
a second calculation unit for detecting the push-pull signal of the sub-beam group based on output signals of the light receiving section group for the sub-beam group,
a third calculation unit for detecting a track error signal by a differential push-pull method based on a difference between the push-pull signal of the main beam and the push-pull signal of the sub-beam group,
a fourth calculation unit for detecting the focus error signal based on an output signals of the other light receiving section group for the main beam.

11. An optical head device comprising:
a light source;
an objective lens for focusing a light emitted from the light source onto a disk-shaped optical recording medium;
a diffractive optical element provided between the light source and the objective lens;
a photodetecting means for receiving a reflected light from the optical recording medium; and
a light splitting unit provided between the objective lens and the photodetecting means, wherein
the diffractive optical element has a function of generating a main beam and sub-beam group, which are focused onto the optical recording medium by the objective lens, from the light emitted from the light source,
the light splitting unit comprises a plurality of regions for generating a plurality of main beam split lights and a plurality of sub-beam group split lights respectively from reflected lights of the main beam and the sub-beam group being reflected by the optical recording medium,
the photodetecting means comprises: light receiving section group for the main beam including a plurality of light receiving means for receiving the plurality of main beam split lights in order to detect a push-pull signal of the main beam; and light receiving section group for the sub-beam group including a plurality of light receiving means for receiving the plurality of sub-beam group split lights in order to detect a push-pull signal of the sub-beam group,
one side of the plurality of main beam split lights with respect to an optical axis of the reflected light and one side of the plurality of light receiving means of the light receiving means group for the main beam with respect to its center are provided so as to correspond, and the other side of the plurality of main beam split lights with respect to the optical axis of the reflected light and the other side of the plurality of light receiving means of the light receiving means group for the main beam with respect to its center are provided so as to correspond.

12. An optical information recording or reproducing apparatus comprising:
the optical head device as claimed in claim 1,
a first calculation means for detecting the push-pull signal of the main beam based on output signals of the light receiving means group for the main beam,
a second calculation means for detecting the push-pull signal of the sub-beam group based on output signals of the light receiving means group for the sub-beam group, and
a third calculation means for detecting a track error signal by a differential push-pull method based on a difference between the push-pull signal of the main beam and the push-pull signal of the sub-beam group.

13. An optical information recording or reproducing apparatus comprising:
the optical head device as claimed in claim 5,
a first calculation means for detecting the push-pull signal of the main beam based on output signals of the light receiving means group for the main beam,
a second calculation means for detecting the push-pull signal of the sub-beam group based on output signals of the light receiving means group for the sub-beam group,
a third calculation means for detecting a track error signal by a differential push-pull method based on a difference between the push-pull signal of the main beam and the push-pull signal of the sub-beam group,
a fourth calculation means for detecting a focus error signal based on an output signal of the other light receiving means group for the main beam.
